(19) United States
(12) Patent Application Publication
(10) Pub. No.: US 2022/0161945 A1
(43) Pub. Date: May 26, 2022

(54) System and Method for Converting Space-Based Ionized Plasma into Electrical Power for Spacecraft Using Magnetohydrodynamic Generation

(71) Applicants: William Vincent Torre, Chula Vista, CA (US); Christopher Nolan Torre, Sherwood, AR (US)

(72) Inventors: William Vincent Torre, Chula Vista, CA (US); Christopher Nolan Torre, Sherwood, AR (US)

(21) Appl. No.: 16/949,919

(22) Filed: Nov. 20, 2020

(51) Int. Cl. B64G 1/44; H02N 3/00

(52) U.S. Cl. CPC B64G 1/446; H02N 3/00

(57) ABSTRACT

This proposed system provides a method to generate electrical power for space-based orbiting satellites, probes, stations, habitations, and interplanetary missions. Electricity is generated by collecting the flow of ionized plasma in the solar system for low earth applications and in the solar wind beyond the earth's magnetosphere, then directing the plasma through a channel using the principle of magneto-hydrodynamics (MHD). The channel has conducting electrodes on two sides and a magnetic field directed orthogonally to the plasma flow direction. This results in an electrical current to power spacecraft functions such as batteries, communications, propulsion, guidance, navigation and control. This MHD generator has the potential of providing higher power generation density (e.g., watts/kg) for spacecraft than photo-voltaic panels. The design includes a control system to maintain voltage quality, regulate electromagnet power and control ion inlet scoop RF frequency and voltage in response to changing space ionized plasma conditions.

### RELATED U.S. APPLICATION DATA

Provisional application No. 62/958,660, filed on: Jan. 8, 2020

### 13 Claims, 9 Drawing Sheets

### REFERENCES CITED

### Prior Art—U.S. Patent Documents

| | | |
|---|---|---|
| 3,122,663 | Feb. 25, 1964 | Kach, A. |
| 3,146,361 | Jun. 6, 1962 | Kafka, Wilhelm |
| 3,149,247 | Sep. 15, 1964 | Cobine, James D. |
| 3,160,768 | Dec. 8, 1964 | Goeschel, H., et. al. |
| 3,162,781 | Dec. 22, 1964 | Sterling, B. and Smith, D. B. |
| 3,165,652 | Jan. 12, 1965 | Prater, Thomas A. |
| 3,179,873 | Apr. 20, 1965 | Rosa, R. J. |
| 3,182,213 | May 4, 1965 | Rosa, R. J. |
| 3,210,642 | Oct. 5, 1965 | Rosa, R. J. |
| 3,211,932 | Oct. 12, 1965 | Hundstad, Richard L. |
| 3,214,615 | Oct. 26, 1965 | Way, Stewart |
| 3,214,616 | Oct. 26, 1965 | Way, Stewart |
| 3,217,190 | Nov. 9, 1965 | McLafferty, George H. |
| 3,223.859 | Dec. 14, 1965 | Corbitt, H. E. |
| 3,247,405 | Apr. 19, 1966 | Rosner, M. |
| 3,319,091 | May 9, 1967 | Friedrich, Burhorn, et. al. |
| 3,319,092 | May 5, 1967 | Keating, Stephen J. |
| 3,348,079 | Oct. 17, 1967 | McKinnon, Charles |
| 3,355,608 | Nov. 28, 1967 | Gebel, R. |
| 3,356,872 | Dec. 5, 1967 | Woodson, Herbert H. |
| 3,395,967 | Aug. 6, 1968 | Karr, Claude |
| 3,397,331 | Aug. 13, 1968 | Burkhard, Kurt |
| 3,414,744 | Dec. 3, 1968 | Petrick, Michael |
| 3,453,462 | Jul. 1, 1969 | Hsu, Yih-Yun |
| 3,478,233 | Nov. 11, 1969 | Prem, L. L. |
| 3,478,234 | Nov. 11, 1969 | Prem, L. L., and Wang, T. C. |
| 3,479,538 | Nov. 18, 1969 | Yerouchalmi, David |
| 3,483,405 | Dec. 9, 1969 | Prem, L. L., and Wang, T. C. |
| 3,489,933 | Jan. 13, 1970 | Meyer, R. G. and Lary, E. C. |
| 3,513,335 | May 19, 1970 | Gordon, Robert, et. al. |
| 3,549,915 | Dec. 22, 1970 | Prem, L. L. |
| 3,660,700 | May 2, 1972 | Aisenberg, S. and Change, K. W. |
| 4,128,776 | Dec. 5, 1978 | Boquist, C. W. and Marchant, D. D. |
| 4,140,931 | Feb. 20, 1978 | Marchant, D. D., et. al. |
| 4,523,113 | Jun. 11, 1985 | Kallman, W. R. and Johnson, M. R. |
| 4,663,548 | May 5, 1987 | Kato, Ken |
| 2012/0104876 | May 3, 2012 | Ma, Yuan-Ron |
| 6,107,628 | Aug. 22, 2000 | Smith, R.D. and Shaffer, Scott |
| 7,064,321 | Jun. 20, 2006 | Franzen, Jochen |
| 7,781,728 | Aug. 24, 2010 | Senko, M. W., et. al. |
| 8,698,075 | Apr. 15, 2014 | Kurulugama, R. T. and Belov, M. E. |
| 9,228,570 | Jan. 5, 2016 | Subrata, Roy |
| 9,249,757 | Feb. 2, 2016 | Zauderer, Bert |
| 9,497,846 | Nov. 15, 2016 | Szatkowski, George, et. al. |
| 9,947,420 | Apr. 17, 2018 | McGuire, Thomas |
| 9,959,942 | May 1, 2018 | McGuire, Thomas |
| 9,967,963 | May 8, 2018 | Zindler, Ryan, et. al. |
| 10,443,139 | Oct. 15, 2019 | Mills, Randell |
| 10,686,358 | Jun. 16, 2020 | Serghine, C., et. al. |

### OTHER PUBLICATIONS

1. “Interplanetary Magnetohydrodynamics”, Burlaga, L. F., 1995, Oxford University Press.
2. “An Introduction to Modem Astrophysics”, Carroll, B. W. and Ostlie, D. A., 1996, Addison-Wesley Publishing Co., Inc.
3. “Physics for Students of Science and Engineering”, Halliday, D. and Resnick, R., 1965, John Wiley & Sons, Inc.
4. http://web.mit.edu/space/www/voyager/voyager_data/voyager_data.html
5. http://directory.eoportal.org/web/eoportal/satellite-missions/u/ulysses
6. https://en.wikipedia.org/wiki/Mu-metal
7. “Magnetohydrodynamic Power Generation”, Ajith Kirshnan, Jinshah, Government Engineering College, Kozhikode, Kerala, India, International Journal of Scientific and Research Publications, Volume 3, Issue 6, June 2013.
8. “Physics of Fully Ionized Gasses”, Spitzer, Lyman, p. 137, equation 5-32, 1962, John Wiley and Sons.
9. “Ion Funnels for the Masses: Experiments and Simulations with a Simplified Ion Funnel”, Julian, R. R., et. al., Aug. 10, 2005, American Society for Mass Spectrometry.
10. “The Ion Funnel: Theory, Implementations, and Applications”, Kelly, R. T., et. al., Apr. 23, 2009, Wiley InterScience.
11. “Hyperphysics”, http://hyperphysics.phy-astr.gsu.edu/hbase/magnetic/solenoid.html.

### BACKGROUND OF THE INVENTION

### 1. Field of Invention

The proposed invention described herein relates to a new and useful method to generate electrical energy to power a number of functions onboard a spacecraft by using the naturally occurring ionized plasma produced by the sun and distributed throughout the solar system (ref. 1, p. 155). This is done by converting the flow of these ionized particles into electrical energy through a magneto-hydrodynamic (MHD) channel. Terrestrially-based MHD systems have traditionally relied on injecting ionized seeding particles into a hot gas flow through magnetic fields with electrodes to collect the electricity generated. This method of seeding hot plasma is not applicable to the proposed method of MHD generation because the naturally occurring space environment has high energy charged ion plasma particles flowing from the sun in earth-orbit and the interplanetary medium of our solar system, and from the interstellar space medium. An inlet scoop directs the ionized flow in space from the direction of the satellite's motion (commonly referred to as the “RAM” direction, that is, the spacecraft side that is impacting/ramming into the space plasma) in low earth orbit or toward the most efficient space plasma flow direction in higher orbits and in interplanetary space.

Spacecraft designers have typically relied upon photovoltaic (PV) solar panels to convert sun light into electricity and then store the energy in onboard batteries to provide spacecraft power to operate a multiplicity of functions. Depending on the altitude and orientation of the spacecraft, a mechanized system of rotational gimbals is used to correctly align the solar panels toward the sun for maximum advantage. PV panels do not produce power when solar light is blocked, such as in the shadow of the earth during orbit. And PV panel efficiency degrades over time due to gradual deterioration of power output from exposure to free atomic oxygen. Complicated mechanical systems and moving parts are used for launch restraint and deployment which creates reliability issues for PV panels. PV panels are also bulky, fragile to manipulate, and heavy in weight, which can impact launch payload limitations. The proposed MHD generation system herein eliminates or minimizes these limitations while providing more spacecraft power than PV.

Plasma in space is a state of matter in which in the presence of ionized charged particles (e.g., positive protons and negative electrons) makes plasma electrically and thermally conductive from the expansion of the solar corona (ref. 2, p. 410). Ionized plasma particles are naturally found in space and are generated in our solar system by our star, the sun, and by interstellar stars beyond our solar system's heliosphere. In low earth orbit this ionized plasma that streams from the sun is trapped by the earth's magnetic field and is found in the ionosphere and the Van Allen belts. Outside of the Van Allen Belts, beyond low earth orbits, the solar plasma has higher concentrations of ionized particles in the solar wind. This naturally occurring ionized plasma can be channeled through the presence of a strong magnetic field to create electrical power in the form of DC (direct current) voltage across collector electrodes that can be used to charge batteries and provide power for other spacecraft electrical functions.

MHD generation was originally proposed by Michael Faraday's Law of Induction in 1831 (ref. 3, pages 780-781) and has been investigated as a source of efficient power generation for many years since Faraday proposed the concept. Previous developments of MHD generation has been focused on terrestrial (earth-based) applications for electrical power production with limited success due to low efficiencies resulting from a high energy to generate the ionized plasma. There was a great deal of interest in MUD generation until the late 1970's since it has no moving parts and potentially could provide theoretically high power conversion efficiencies in the range 60-65%. The absence of moving parts offers the potential of higher reliability and a longer life-span than power generation methods such as steam and gas turbines. Unfortunately, the high efficiencies that were expected were unable to be obtained due to the high amount of energy consumption to create the high plasma temperatures, density, velocities, and overcome plasma instability issues. These are of less importance for space-based applications due to the relatively lower power of spacecraft needs and because the ionized plasma naturally has a very high velocity that exists in the space environment.

### 2. Discussion of Prior Art, U.S.

MHD generation has been investigated as prior art and tested for terrestrial applications of power generation, not for space power applications as proposed herein. No known use of MHD generation using the naturally ionized plasma from the sun's coronal expansion as proposed herein for space based applications has been developed. After review of the following patents, none have been found to have significance to the use of MHD generation utilizing the sun's plasma flux for space-based power applications. In addition, MHD generation has not been proposed which utilizes an inlet scoop oriented in the RAM direction in low earth orbit and that could be positionable toward the most efficient space plasma flow direction in higher orbits and in interplanetary systems. Additionally, a space-based MHD generator would utilize a voltage regulation circuit to control and adjust the voltage output and a power regulation circuit to control the electromagnet coils and thus control the amount of power produced while maintaining a level to match the spacecraft power consumption load.

The following is a review of prior patents related to MHD generation. Our MHD generator system proposed herein differs significantly from previous patents regarding MHD generation. Ours is the first application using MHD generation to provide spacecraft power while the MHD generation patents to-date were for power production on earth. The proposed space based MHD generator system is significantly different than terrestrial applications. In a terrestrial application of MHD generation, the generator is fixed to the ground, and the ionized plasma is man-made, and the direction, velocity, density, and properties of the ionized plasma is controlled very precisely. In the proposed space based MHD generation the characteristics of the properties of the ionized plasma is uncontrolled and exists naturally in space; there is little control over plasma direction, velocity, density that variously changes in space. In a space-based MHD generator, a control system is used to sense and measure the space ionized plasma conditions and adjust the power to the electromagnets, voltage at the electrodes and orientation of the MHD inlet scoop or spacecraft to ensure and regulate power production via the ion plasma scoop that is designed to funnel and concentrate space plasma. These features are not found on previous terrestrial applications of MHD generation. Due to the varying characteristics of space plasma, control circuits are designed to regulate voltage magnitude, eliminate voltage transients, and regulate the electromagnet currents for power production. By comparison terrestrial MHD generators do not change in orientation nor is control circuitry applicable since the ionized plasma direction and properties are controlled. Also, for a space based MHD generator, grounding and shielding elements eliminate magnetic field interference and static-discharge arcing that can occur in space that is not found on terrestrial MHD generator applications. Our proposed MHD generation for spacecraft is designed to minimize weight and volume for payload launch program specifications. These limitations are generally not a concern for terrestrial, ground-based MHD generation design. Payload launch mass limitations impose a significant concern for a space based MHD generator. Our proposed space based MHD generation system addresses these issues and thus is significantly different than previously patented terrestrial applications of MHD electrical power generation.

Terrestrial MHD generators cannot produce ionized plasma with the high ionized particle velocities, 200 km/sec-700 km/sec at 1 Astronomical Unit (AU) from the sun, found in space (ref. 2, p. 408, and ref. 4). By comparison terrestrial based applications of MHD generation plasma has a low velocity in the range of 0.3 km/sec, -0.45 km/sec and use very hot gas plasmas to seed with ions. Low ionized plasma velocity results in low power generation. Also the hot gases used in terrestrial applications tend to reduce plasma conductivity and thus power generation. The low plasma velocity and high temperature is primarily why terrestrial applications of MHD generation have not been efficient or successful. Whereas space plasma particle kinetic temperatures are very low and are approximately 4×10⁴° K for protons and 10⁵° K for electrons, with 1-2 eV (electron-Volts, ref.'s 1 and 2, p. 408), and space plasma has a high electrical conductivity which is the perfect combination for producing power using MHD generation. The high ion plasma velocity and high conductivity found in space are a combination that results in high power production potential.

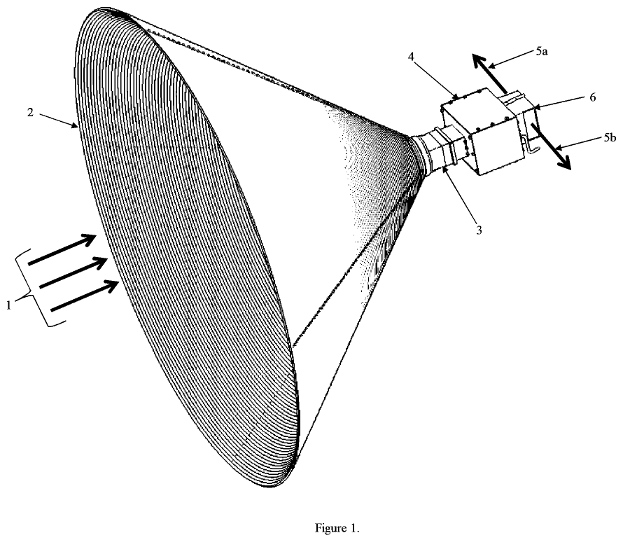

U.S. Pat. No. 3,122,663 A to Kach (1964) describes a uni-axial MHD generator of tubular construction in FIGS. 1a and 1b through which a high temperature ionized gas is passed through a magnetic field that is arranged with no electrodes. The seeded gas originates from an upstream combustion chamber and passes through the magnetic structures that can be arranged for alternative phase electrical systems. While this is useful for producing alternating phase currents for electrical power generation, it is not useful to extract electrical power from space-based ion plasma, because it does not address the issues of the varying, high velocity, or low temperature characteristics found in space ionized plasma. Low temperature charged ion plasma particle flows generated by the sun in earth-orbit and interplanetary or interstellar space plasmas would utilize a simpler MHD channel arranged of magnets and electrodes coupled with an inlet scoop oriented in the RAM direction in low earth orbit or toward the most efficient space plasma flow direction in higher orbits and in interplanetary systems. Plus a control system is used to regulate the magnetic fields surrounding the MHD channel and the radio frequency (RF) voltages surrounding the inlet scoop.

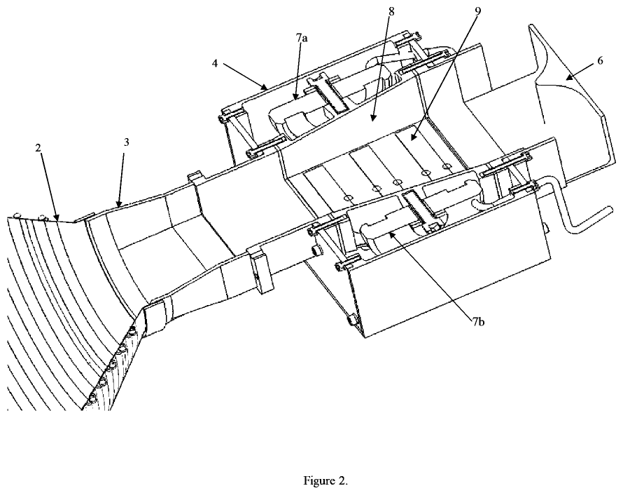

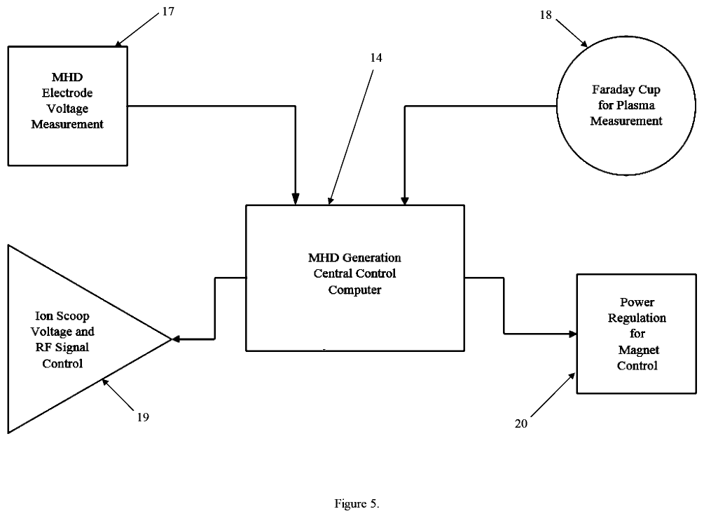

U.S. Pat. No. 3,146,361 A to Kafka (1962) describes a MHD generator within which a rotor in FIG. 1 is coaxially rotatable in a stator assembly FIG. 2 with magnetic means for producing electrical current during rotation in magnetic alternating fields transverse to the flow of an ionized gas flow medium between respective mutually insulated pairs or systems of electrodes FIG. 5. While this is useful for producing a single, dual or three phase alternating currents for electrical power generation, it is not useful to extract electrical power from space-based ion plasma because it does not address the issues of the varying, high velocity, or low temperature characteristics found in space ionized plasma. Low temperature charged ion plasma particle flows generated by the sun in earth-orbit and interplanetary or interstellar space plasmas have no need for rotatable components within the MHD channel. Additionally, an inlet scoop can be oriented in the RAM direction in low earth orbit and adjusted toward the most efficient space plasma flow direction in higher orbits and in interplanetary systems with a control system to regulate the RF voltages surrounding the inlet scoop. Plus a control system is used to regulate the magnetic fields surrounding the MHD channel and the radio frequency (RF) voltages surrounding the inlet scoop.

U.S. Pat. No. 3,149,247 A to Cobine (1964) describes a channel in FIGS. 2, 3, 4, 5 and 7 in which hot, conductive combustion gases are passed through and converted from thermal energy to electrical energy. This high-temperature, ion-seeded working fluid is forced to flow through the MHD generator channel in the direction of the arrow 79. Electric loads 81, 82 and 83 are connected to selected electrodes by means of conductors 84. A pair of magnetic pole pieces 125 and 126 are located above and below the fluid flow portion of channel 110 and are used to establish the magnetic field to facilitate the generation of electrical energy. This method could be used to produce currents for terrestrially-based electrical power generation. It is not practicable to extract electrical power from a space-based, low temperature charged ion plasma particle flow that is created by the sun in earth-orbit and interplanetary or interstellar space plasmas which do not create hot, seeded gaseous plasmas. Further, it does not address the issues of the varying density or high velocity characteristics found in space ionized plasma. Additionally, in a space application, an inlet scoop can be favorable oriented in the RAM direction in low earth orbit and adjusted toward the most efficient space plasma flow direction in higher orbits and in interplanetary systems. Plus a control system can be used to regulate the magnetic fields surrounding the MHD channel and the radio frequency (RF) voltages surrounding the inlet scoop.

U.S. Pat. No. 3,160,768 A to Goeschel (1964) is a channel structure within which a hot, ionization-seeded combustion gas is passed through a transverse magnetic field with electrodes on the opposite lateral walls, ref. FIG. 1. The electrodes are positioned by feed drive motors with a photoelectric barrier that provides feedback to determine the optimum position for electrical output. For these electrodes, sinterable, electrically conducting substances in pulverulent form are filled into a tube and the tube is used as an electrode. This method could be used to produce currents for terrestrially-based electrical power generation with an improved electrode system. It is not practicable to extract electrical power from a space-based ion plasma, because it does not address the issues of the varying, high velocity, or low temperature characteristics found in space ionized plasma that is created by the sun in earth-orbit and interplanetary or interstellar space plasmas. Additionally, an inlet scoop can be favorably oriented into the RAM direction in low earth orbit and also adjusted toward the most efficient space plasma flow direction in higher orbits and in interplanetary space. Plus a control system can be used to regulate the magnetic fields surrounding the MHD channel and the radio frequency (RF) voltages surrounding the inlet scoop.

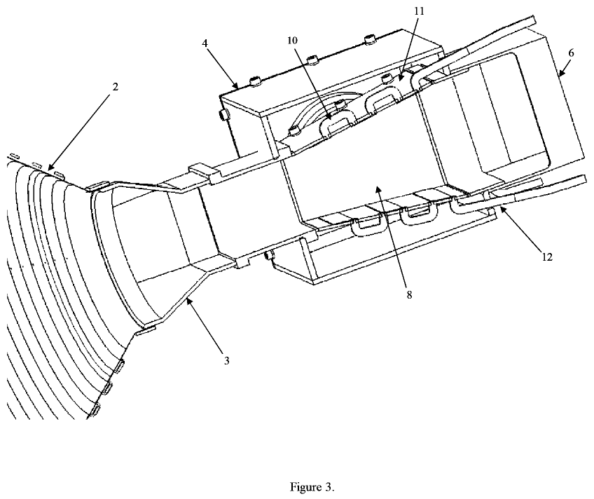

U.S. Pat. No. 3,162,781 A to Sterling (1964) is for an MHD system that has an integral method of mixing fuel and air to create a hot combustion gas. The seed material for ionization is introduced as a component mixed with a consumable electrode. FIGS. 1 and 3 are cross-sectional views through the device. A plurality of carbon plates 40 creates a number of gas passages or spaces 42. A magnetic field is positioned such that it is generally perpendicular to the flow. While this method is useful for producing alternating currents for electrical power generation, it is not applicable to extract electrical power from space-based ion plasma because it does not address the issues of the varying, high velocity, or low temperature characteristics found in space ionized plasma. An inlet scoop oriented in the RAM direction can be used in low earth orbit and also toward the most efficient space plasma flow direction in higher orbits and in interplanetary space. Plus a control system is used to regulate the magnetic fields surrounding the MHD channel and the radio frequency (RF) voltages surrounding the inlet scoop.

U.S. Pat. No. 3,165,652 A to Prater (1962) is for a specific type of electrode structure to be used in a MHD device in which the electrode is exposed to a conductive, gaseous fluid which is electrically conductive by heating the gas to a high temperature to create an ionized gaseous stream that flows through the generator and, by virtue of its movement relative to the magnetic field, it thus induces a current between opposed electrodes. This system is useful for generating alternating current electricity that is exposed to thousands of degrees Kelvin in a stationary hot gas environment. It is not useful to extract electrical power from space-based, low temperature charged ion plasma particle flows generated by the sun in earth-orbit and interplanetary or interstellar space plasmas. While this method is useful for producing alternating currents for electrical power generation, it is not practicable to extract electrical power from a space-based ion plasma, because it does not address the issues of the varying, high velocity, or low temperature characteristics found in space ionized plasma flow that is created by the sun in earth-orbit, interplanetary or interstellar space plasmas. Further, for a space application, an inlet scoop oriented in the RAM direction can be used in low earth orbit and also toward the most efficient space plasma flow direction in higher orbits and in interplanetary space. Plus a control system can be used to regulate the magnetic fields surrounding the MHD channel and the radio frequency (RF) voltages surrounding the inlet scoop.

U.S. Pat. No. 3,179,873 A to Rosa (1965) is an MHD generator that produces alternating current power by the flow of a hot, seeded, electrically conductive gas through the middle of magnetic field passages. This method could be used to produce alternating currents for electrical power generation by switching the circuit elements to develop alternating current power output. It is not applicable to extract electrical power from space-based ion plasmas because it does not address the issues of the varying, high velocity, or low temperature characteristics found in space that is created by the sun in earth-orbit, or in interplanetary or interstellar space plasmas. Further, for a space application, an inlet scoop oriented in the RAM direction can be used in low earth orbit and also toward the most efficient space plasma flow direction in higher orbits and in interplanetary space. Plus a control system can be used to regulate the magnetic fields surrounding the MHD channel and the radio frequency (RF) voltages surrounding the inlet scoop. Plus a control system is used to regulate the magnetic fields surrounding the MHD channel and the radio frequency (RF) voltages surrounding the inlet scoop.

U.S. Pat. No. 3,182,213 A to Rosa (1965) is an MHD generator using a Hall effect to produce electrical current power by moving an electrically conductive high temperature gas seeded with electrons and positive ions into the plasma. The Hall current results from the force of the magnetic field on a moving charge. By virtue of such movements, separation of negative and positive charges occurs in the plasma, resulting in a potential gradient, or Hall potential, along the length of its flow. Under the influence of the Hall potential, Hall currents may circulate longitudinally through the plasma if a closed circuit is available. This method could be used to produce currents for terrestrially-based electrical power generation. It is not useful to extract electrical power from a space-based ion plasma because it does not address the issues of the varying, high velocity, or low temperature characteristics found in space ionized plasma flow that is created by the sun in earth-orbit, interplanetary or interstellar space plasmas. Additionally, an inlet scoop is oriented in the RAM direction in low earth orbit and toward the most efficient space plasma flow direction in higher orbits and in interplanetary space.

U.S. Pat. No. 3,210,642 A to Rosa (1965) is an MHD generator for producing alternating current power by rotating the magnetic field relative to the electrodes with a hot, conductive gas passing through the middle of the device. The gas could be seeded with sodium, potassium, Cesium, or an alkali metal vapor to make it electrically conductive. This method could be used to produce alternating currents for terrestrially-based electrical power generation. It is not useful to extract electrical power from a space-based ion plasma because it does not address the issues of the varying, high velocity, or low temperature characteristics found in space ionized plasma flow that is created by the sun in earth-orbit and interplanetary or interstellar space plasmas. Further, for a space application, an inlet scoop oriented in the RAM direction can be used in low earth orbit and also toward the most efficient space plasma flow direction in higher orbits and in interplanetary space. Plus a control system can be used to regulate the magnetic fields surrounding the MHD channel and the radio frequency (RF) voltages surrounding the inlet scoop.

U.S. Pat. No. 3,211,932 A to Hundstad (1965) is a method for transporting a high temperature gas that is seeded with an alkali metal to make it conductive as it passes through a transverse magnetic field shown in FIGS. 1 and 2. Current collecting electrodes are disposed along the flow of the conductive working fluid to collect current that is generated due to the movement of the electrically conducting gas through the magnetic field. While this method is useful for producing electrical power generation from seeded ionized hot gases, it is not useful to extract electrical power from a space-based ion plasma, because it does not address the issues of the varying, high velocity, or low temperature characteristics found in space ionized plasma particle flow that is created by the sun in earth-orbit, interplanetary or interstellar space plasmas. Further, for a space application, an inlet scoop oriented in the RAM direction can be used in low earth orbit and also toward the most efficient space plasma flow direction in higher orbits and in interplanetary space. Plus a control system can be used to regulate the magnetic fields surrounding the MHD channel and the radio frequency (RF) voltages surrounding the inlet scoop.

U.S. Pat. No. 3,214,615 A to Way (1965) uses a plurality of magnetohydrodynamic generator stages to generate electrical energy by the passage of a hot ionized working fluid within it; the working fluid being seeded with an alkali metal to cause it to more readily ionize, and with heat energy being applied to the working fluid between stages in order to maintain the working fluid in a highly conductive state. This is for a stationary generation system with a large amount of hot, seeded gas flow. This method is useful for producing terrestrial electrical power generation from seeded ionized hot gases. It is not useful to extract electrical power from a space-based ionic plasma because it does not address the issues of the varying density, high velocity, or low temperature characteristics found in space ionized plasma particle flow that is created by the sun in earth-orbit, interplanetary or interstellar space plasmas which do not have the high temperature, alkali-seeded flows with successive stage-heating arrangements as described in this patent. Further, for a space application, an inlet scoop oriented in the RAM direction can be used in low earth orbit and also toward the most efficient space plasma flow direction in higher orbits and in interplanetary space. Plus a control system can be used to regulate the magnetic fields surrounding the MHD channel and the radio frequency (RF) voltages surrounding the inlet scoop.

U.S. Pat. No. 3,214,616 A to Way and Hundstad (1965) is similar to U.S. Pat. No. 3,214,615 A with a difference in the manner high temperature ionized gas is more economically seeded with cesium since the refractory products are recovered for re-use or as a by-product of the energy conversion process, as shown in FIG. 1. This MHD system can be used to generate electricity from a seeded hot gas, terrestrially-based generator installation. It is not useful to extract electrical power from cold space-based ionic plasma because it does not address the issues of the varying, high velocity, or low temperature characteristics found in space ionized plasma. Plasma particle flows generated by the sun in earth-orbit or in interplanetary or interstellar space plasma would also use an inlet scoop oriented in the RAM direction to collect plasma in low earth orbit and positionable toward the most efficient space plasma flow direction in higher orbits and in interplanetary space. Plus a control system can be used to regulate the magnetic fields surrounding the MHD channel and the radio frequency (RF) voltages surrounding the inlet scoop.

U.S. Pat. No. 3,217,190 A to McLafferty (1965) is a spiral MHD generator in which the hot gas working fluid is routed through a spiral-shaped channel (see FIGS. 1 and 2), the passages of which are lined with electrodes. Magnetic field windings are installed around the outside of the case in FIG. 3. This MHD system can be used to generate electricity from a seeded hot gas, terrestrially-based generator installation. It is not useful to extract electrical power from cold space-based ionic plasma because it does not address the issues of the varying, high velocity, or low temperature characteristics found in space ionized plasma. Plasma particle flows generated by the sun in earth-orbit or in interplanetary or interstellar space plasma would use an inlet scoop oriented toward the RAM direction to collect plasma in low earth orbit and positionable toward the most efficient space plasma flow direction in higher orbits and in interplanetary space. Plus a control system can be used to regulate the magnetic fields surrounding the MHD channel and the radio frequency (RF) voltages surrounding the inlet scoop.

U.S. Pat. No. 3,223,859 to Corbitt (1965) is for alternating current production from a hot gas system by means of a vortex within a gas flow chamber with a rotatable magnet 42 inside the chamber 12 as depicted in FIGS. 2 and 3. The rotation of this magnet alternates the flux direction in the magnetic material so that the magnetic field in the gas flow chamber alternates in accordance with the rotation of the magnet. Hot gas is provided from the exhaust of a gas, steam, or nuclear driven turbine. Electrodes are mounted in the chamber and positioned to receive electrons moving with the gas stream that will be deflected by the magnetic field. This MHD system can be used to generate electricity from a seeded hot gas, terrestrial-based generator installation. It is not practically applicable to extract electrical power from cold space-based ionic plasma because it does not address the issues of the varying, high velocity, or low temperature characteristics found in space ionized plasma. Further, for space applications, an inlet scoop oriented in the RAM direction can be used in low earth orbit and also toward the most efficient space plasma flow direction in higher orbits and in interplanetary space. Plus a control system can be used to regulate the magnetic fields surrounding the MHD channel and the radio frequency (RF) voltages surrounding the inlet scoop.

U.S. Pat. No. 3,247,405 A to Rosner (1966) relates to MHD generation of electrical power using one or more pairs of spaced electrode plates 4 arranged transversely to a hot ionized gas flow moving at high velocity through the channel in an axial direction between the pairs of electrodes and magnetic field H that causes an electrical potential to be produced at these electrodes, ref. FIGS. 1 and 2. The hot gas is created by a combustion process upstream of the device. This MHD system can be used to generate electricity from a seeded hot gas, terrestrially-based generator installation. This is not practical to extract electrical power from cold space-based charged ion plasma because it does not address the issues of the varying, high velocity, or low temperature characteristics found in space ionized plasma. Particle flows generated by the sun in earth-orbit or in interplanetary or interstellar space plasma need an inlet scoop oriented in the RAM direction to collect plasma in low earth orbit and positionable toward the most efficient space plasma flow direction in higher orbits and in interplanetary space. Plus a control system can be used to regulate the magnetic fields surrounding the MHD channel and the radio frequency (RF) voltages surrounding the inlet scoop.

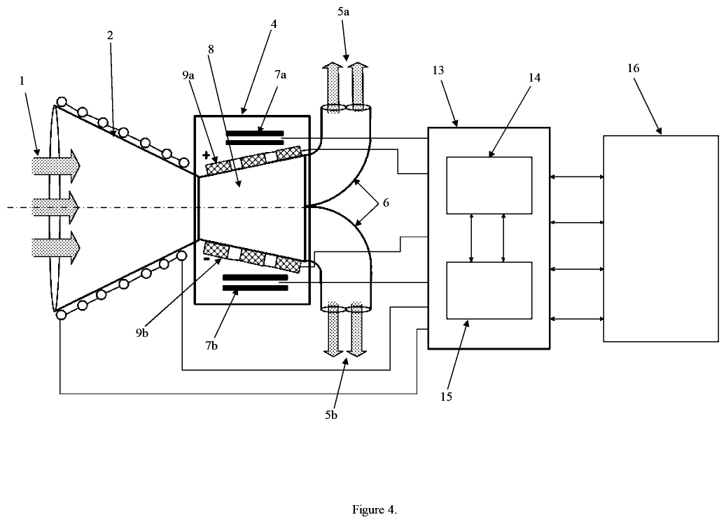

U.S. Pat. No. 3,319,091 A to Burhorn (1967) is a method of operating high temperature MHD generators with hot, electrically conductive gaseous plasmas (approx. 3,000° C.) flowing through a channel that is intersected by a magnetic field so that an electric current is induced perpendicular to the magnetic field and perpendicular to the flow direction of the gas. Electrodes are arranged in FIGS. 3 and 4 within the conducting zone of the hot gas jet such that the maximum possible current intensity is proportional to the surface area of the electrodes. This MHD system can be used to generate electricity from a seeded hot gas, terrestrially-based generator installation. It is not practicable to extract electrical power from cold, space-based charged ion plasma because it does not address the issues of the varying, high velocity, or low temperature characteristics found in space ionized plasma. Particle flows generated by the sun in earth-orbit or in interplanetary or interstellar space plasma need an inlet scoop oriented in the RAM direction to collect plasma in low earth orbit and positionable toward the most efficient space plasma flow direction in higher orbits and in interplanetary space. Plus a control system can be used to regulate the magnetic fields surrounding the MHD channel and the radio frequency (RF) voltages surrounding the inlet scoop.

U.S. Pat. No. 3,319,092 A to Keating (1967) is for a construction technique, FIGS. 2 and 3, that enables seeded, ionized hot gas plasma to flow in a chamber with insulating sidewalls that resists plasma pressures while permitting thermal expansion and which resists cracking and supersonic flutter due to the use of small ceramic pieces. The sidewalls are arranged in a tile pattern with underlying water passages for cooling. This MHD system can be used to generate electricity from a seeded hot gas, terrestrially-based generator installation. This is not practically applicable to extract electrical power from cold space-based charged ion plasma because it does not address the issues of the varying, high velocity, or low temperature characteristics found in space ionized plasma. Particle flows generated by the sun in earth-orbit or in interplanetary or interstellar space plasma would use an inlet scoop oriented in the RAM direction to collect plasma in low earth orbit and positionable toward the most efficient space plasma flow direction in higher orbits and in interplanetary space. Plus a control system can be used to regulate the magnetic fields surrounding the MHD channel and the radio frequency (RF) voltages surrounding the inlet scoop.

U.S. Pat. No. 3,348,079 A to McKinnon (1967) presents a pulse MHD system that has no separate external magnetic field, thus making it more compact. FIG. 1 shows this pulse MHD system in which a composite of explosive and magnetic materials are detonated parallel to the plane of conductors 22 and 24, the hot ionized gaseous products of which transverse an upstanding prong (conductor) to draw electrical power. This MHD system can be used to generate electricity from a seeded hot gas, terrestrially-based generator installation. This is not useful to extract electrical power from cold space-based charged ion plasma because it does not address the issues of the varying, high velocity, or low temperature characteristics found in space ionized plasma. Particle flows generated by the sun in earth-orbit or in interplanetary or interstellar space plasma would not use pulsating components in the MHD channel. Particle flows generated by the sun in earth-orbit or in interplanetary or interstellar space plasma would use an inlet scoop oriented in the RAM direction to collect plasma in low earth orbit and positionable toward the most efficient space plasma flow direction in higher orbits and in interplanetary space. Plus a control system can be used to regulate the magnetic fields surrounding the MHD channel and the radio frequency (RF) voltages surrounding the inlet scoop.

U.S. Pat. No. 3,478,233 A to Prem (1969) is for a method to control a working fluid having liquid and vapor phases by decreasing the vapor volume via a flow regulator 68 to improve the electrical conductivity, see FIG. 1. The conductive fluid moves through a magnetic field with guide vanes, FIGS. 2 and 3. Electrodes 14 and 16 function as current collectors and are connected to an external load. This MHD system can be used to generate electricity from a seeded hot gas, terrestrially-based generator installation. This is not practicable to extract electrical power from cold, space-based charged ion plasma because it does not address the issues of the varying, high velocity, or low temperature characteristics found in space ionized plasma. Particle flows generated by the sun in earth-orbit or in interplanetary or interstellar space plasma would use an inlet scoop oriented in the RAM direction to collect plasma in low earth orbit and positionable toward the most efficient space plasma flow direction in higher orbits and in interplanetary space. Plus a control system can be used to regulate the magnetic fields surrounding the MHD channel and the radio frequency (RF) voltages surrounding the inlet scoop.

U.S. Pat. No. 3,355,608 A to Gebel (1967) is for a compact construction technique to enable ionized hot gas plasma to flow in a helical path between coaxial electrodes in a unidirectional magnetic field as seen in FIGS. 1 and 2. This generates direct current. For directly producing an alternating current of electricity, for example, traveling or rotating magnetic fields or a pulsating flow of plasma may be employed. This MHD system can be used to generate electricity from a seeded hot gas, terrestrially-based generator installation. This is not useful to extract electrical power from cold space-based charged ion plasma because it does not address the issues of the varying, high velocity, or low temperature characteristics found in space ionized plasma. Particle flows generated by the sun in earth-orbit or in interplanetary or interstellar space plasma would use an inlet scoop oriented in the RAM direction to collect plasma in low earth orbit and positionable toward the most efficient space plasma flow direction in higher orbits and in interplanetary space. Plus a control system can be used to regulate the magnetic fields surrounding the MHD channel and the radio frequency (RF) voltages surrounding the inlet scoop.

U.S. Pat. No. 3,356,872 A to Woodson (1967) is for an open channel, shown in FIG. 1, through which a high temperature, supersonic, electrically conductive, ionized gas or fluid is passed with an arrangement of electromagnets and conductors surrounding the channel to produce two phase, three phase or four phase alternating current electricity. This MHD system can be used to generate electricity from a seeded hot gas, terrestrially-based installation. This is not practicable for electrical power production from cold space-based charged ion plasma because it does not address the issues of the varying, high velocity, or low temperature characteristics found in space ionized plasma. Particle flows generated by the sun in earth-orbit or in interplanetary or interstellar space plasma can utilize an inlet scoop oriented in the RAM direction to collect plasma in low earth orbit and positionable toward the most efficient space plasma flow direction in higher orbits and in interplanetary space. Plus a control system can be used to regulate the magnetic fields surrounding the MHD channel and the radio frequency (RF) voltages surrounding the inlet scoop.

U.S. Pat. No. 3,395,967 A to Karr (1968) is a method for providing two gaseous mixtures with different compositions and different proportions of oxidant with respect to the fuel with different temperatures (hot at approx. 3,000° K and cooler at around 2,000° K) to increase the specific power output to a considerable extent. Accordingly, the device comprises means located upstream of a rotating disc 7 which is designed to bring the two fuel mixtures into the ducts open onto a first face of rotating disc 7 which is pierced by a plurality of ports that are located at intervals in staggered relation in two concentric rings and which are intended to move in front of the outlets of the exhaust ducts. While this is a method to improve MHD efficiency of a terrestrially-based installation, it is not useful to extract electrical power from cold space-based charged ion plasma, because it does not address the issues of the varying, high velocity, or low temperature characteristics found in space ionized plasma. Particle flows generated by the sun in earth-orbit or in interplanetary or interstellar space plasma can utilize an inlet scoop oriented in the RAM direction to collect plasma in low earth orbit and positionable toward the most efficient space plasma flow direction in higher orbits and in interplanetary space systems. Plus a control system can be used to regulate the magnetic fields surrounding the MHD channel and the radio frequency (RF) voltages surrounding the inlet scoop.

U.S. Pat. No. 3,397,331 to Burkhard (1968) is for a specific type of electrode to be used in a MHD device in which the electrode is exposed to high temperature, corrosive metallic oxide fluids which are electrically conductive. The plasma that is employed is an electrically conductive gas from a high temperature, high pressure source that flows through the generator and by virtue of its movement relative to the magnetic field, it thus induces an electromotive force between opposed electrodes within the generator. For seeding purposes, sodium, potassium, cesium or an alkali metal vapor could be used. This system is useful for generating electricity from a terrestrially-based MHD source for electrical power generation. This is not useful to extract electrical power from space-based charged ion plasma because it does not address the issues of the varying, high velocity, or low temperature characteristics found in space ionized plasma particle flows that are generated by the sun in earth-orbit or in interplanetary or interstellar space plasma environments. Plus a control system can be used to regulate the magnetic fields surrounding the MHD channel and the radio frequency (RF) voltages surrounding the inlet scoop.

U.S. Pat. No. 3,414,744 A to Petrick (1968) is for a two-phase liquid metal MHD generator that orients magnets and electrodes around the perimeter of the liquid metal (from a cooled reactor) operating in the temperature range of 1,000 to 1,600° F., as shown in FIGS. 2, 3, 4 and 5. This MHD system can be used to generate electricity from a hot, conductive working fluid in a terrestrially-based generator installation. This is not practicable to extract electrical power from cold space-based charged ion plasma because it does not address the issues of the varying, high velocity, or low temperature characteristics found in space ionized plasma particle flows that are generated by the sun in earth-orbit or in interplanetary or interstellar space plasma environments. Particle flows generated by the sun in earth-orbit or in interplanetary or interstellar space plasma can utilize an inlet scoop oriented in the RAM direction to collect plasma in low earth orbit and positionable toward the most efficient space plasma flow direction in higher orbits and in interplanetary space systems. Plus a control system can be used to regulate the magnetic fields surrounding the MHD channel and the radio frequency (RF) voltages surrounding the inlet scoop.

U.S. Pat. No. 3,453,462 A to Hsu (1969) is for a slug-flow MHF generator, ref. FIG. 1, in which a heated nonconductive gas of high kinetic energy and a liquid metal mist of high kinetic energy are directed from a mixing chamber to a magnetohydrodynamic generator in such proportions that the liquid metal coalesces into slugs of metal. This MHD system may be useful to generate electricity from a hot, conductive working fluid in a terrestrially-based generator installation. This is not practicable to extract electrical power from cold space-based charged ion plasma because it does not address the issues of the varying, high velocity, or low temperature characteristics found in space ionized plasma particle flows that are generated by the sun in earth-orbit or in interplanetary or interstellar space plasma environments. Particle flows generated by the sun in earth-orbit or in interplanetary or interstellar space plasma can utilize an inlet scoop oriented in the RAM direction to collect plasma in low earth orbit and positionable toward the most efficient space plasma flow direction in higher orbits and in interplanetary space systems. Plus a control system can be used to regulate the magnetic fields surrounding the MHD channel and the radio frequency (RF) voltages surrounding the inlet scoop.

U.S. Pat. No. 3,478,234 A to Prem and Wang (1969) is for an alternating current MHD generator that develops a traveling magnetic wave between the entrance and exit regions of a hot gas working fluid, as depicted in FIGS. 1 and 3, in a manner so that constant pressure is developed in the working fluid. This system is useful for generating electricity from a seeded electrically conductive hot working fluid downstream from a heat source and nozzle for alternating current (AC) electrical power generation. This is not practicable to extract electrical power from space-based charged ion cold plasma because it does not address the issues of the varying, high velocity, or low temperature characteristics found in space ionized plasma environments with particle flows generated by the sun in earth-orbit or in interplanetary or interstellar space plasmas. The plasma flows that are generated by the sun in earth-orbit or in interplanetary or interstellar space plasma can utilize an inlet scoop oriented in the RAM direction to collect plasma in low earth orbit and positionable toward the most efficient space plasma flow direction in higher orbits and in interplanetary space systems. Plus a control system can be used to regulate the magnetic fields surrounding the MHD channel and the radio frequency (RF) voltages surrounding the inlet scoop.

U.S. Pat. No. 3,479,538 to Yerouchalmi (1969) is a composite electrode for an MHD generator that has a refractory oxide surface in contact with the heated zone in a thermally and electrically conductive metal box which is cooled by water. The electrode is for an elevated temperature (2,000 to 3,000° K) use in an open cycle system and is coated with certain refractory oxides (e.g. calcium, yttrium, zirconium or thorium) as depicted in FIG. 1 which is a general arrangement of the composite electrode. This MHD system can be used to generate electricity from a seeded hot gas, terrestrially-based generator installation. This is not practicable to extract electrical power from cold space-based charged ion plasma particle because it does not address the issues of the varying, high velocity, or low temperature characteristics found in space. Plasma flows created by the sun in earth-orbit, in the interplanetary medium, or in the interstellar space plasma would utilize an inlet scoop oriented in the RAM direction to collect plasma in low earth orbit and positionable toward the most efficient space plasma flow direction in higher orbits and in interplanetary systems, and need voltage regulation circuits of the voltage output and the electromagnet due to the variable nature of space plasma flow.

U.S. Pat. No. 3,483,405 A to Prem, L. L., and Wang, T. C. (1969) is for an alternating current MHD generator that moves a seeded electrically conductive hot working fluid through magnetic pole pairs between the entrance and exit regions of a generator wherein the successive magnetic pole pairs have a predetermined wave length that is less than the wave length of the preceding magnetic pole pair so that the velocity of the resulting travelling magnetic field matches the decreasing velocity of a working fluid passing through the MHD generator as depicted in FIGS. 3 and 4. This system is also useful for generating electricity from a seeded electrically conductive working fluid for terrestrially-based electrical power generation. This is not useful to extract electrical power from space-based charged ion cold plasma because it does not address the issues of the varying, high velocity, or low temperature characteristics found in space ionized plasma flows created by the sun in earth-orbit or in interplanetary or interstellar space. Plasma flows created by the sun in earth-orbit, in the interplanetary medium, or in the interstellar space plasma would utilize an inlet scoop oriented in the RAM direction to collect plasma in low earth orbit and positionable toward the most efficient space plasma flow direction in higher orbits and in interplanetary systems, and need voltage regulation circuits of the voltage output and the electromagnet due to the variable nature of space plasma flow.

U.S. Pat. No. 3,489,933 A to Meyer and Lary (1970) is for a main duct that passes a hot, seeded conductive gas through for production of pulsating or alternating current (AC). This system has electrodes placed within the working fluid and a separate power extraction coil 58 surrounding the duct with an electromagnetic shield 60 around the coil, and a powered solenoid coil 54 around the shield, as shown in FIG. 4. This MHD system can be used to generate electricity from a hot, conductive working flow in a terrestrially-based generator installation. This is not practicable to extract electrical power from cold space-based charged ion plasma because it does not address the issues of the varying, high velocity, or low temperature characteristics found in space ionized plasma. Particle flows generated by the sun in earth-orbit or in interplanetary or interstellar space plasma can utilize an inlet scoop oriented in the RAM direction to collect plasma in low earth orbit and positionable toward the most efficient space plasma flow direction in higher orbits and in interplanetary space. Plasma flows created by the sun in earth-orbit, in the interplanetary medium, or in the interstellar space plasma would utilize an inlet scoop oriented in the RAM direction to collect plasma in low earth orbit and positionable toward the most efficient space plasma flow direction in higher orbits and in interplanetary systems, and need voltage regulation circuits of the voltage output and the electromagnet due to the variable nature of space plasma flow.

U.S. Pat. No. 3,513,335 A to Gordon (1970) is for an MHD cycle that provides a novel method of introducing electrical conductivity or ionization into the hot working gas (approx. 2,200° K) by means of mixing nuclear fission fragments (from a nuclear power source) and compressing the working fluid through an MHD duct; see FIGS. 1 thru 7 for diagrammatic depictions of this working method. This MHD system could be used to generate electricity from a hot, conductive working gas that is ionized by nuclear fission fragments in a terrestrially-based generator installation. It is not practicable to extract electrical power from the cold space-based charged ion plasma because it does not address the issues of the varying, high velocity, or low temperature characteristics found in space ionized plasma. Particle flows that are generated by the sun in earth-orbit or in interplanetary or interstellar space plasma can utilize an inlet scoop oriented in the RAM direction to collect plasma in low earth orbit and positionable toward the most efficient space plasma flow direction in higher orbits and in interplanetary space. Plasma flows created by the sun in earth-orbit, in the interplanetary medium, or in the interstellar space plasma would utilize an inlet scoop oriented in the RAM direction to collect plasma in low earth orbit and positionable toward the most efficient space plasma flow direction in higher orbits and in interplanetary systems, and need voltage regulation circuits of the voltage output and the electromagnet due to the variable nature of space plasma flow. Plus a control system is used to regulate the magnetic fields surrounding the MHD channel and the radio frequency (RF) voltages surrounding the inlet scoop.

U.S. Pat. No. 3,549,915 A to Prem (1970) is for a method to provide the generation of pulsed electrical power at high energy levels by the sequential discharge of a seeded, ionized electrically conductive plasma fluid from supply tanks 18 and 20 through an MHD generator by sequencing the supply tanks through control valves so that a high energy pulse power is generated for a relatively longtime duration. This MHD system may be used to generate electricity from a hot, ionized, conductive working flow in a terrestrially-based AC generator installation. This is not practicable to extract DC electrical power from cold space-based charged ion plasma because it does not address the issues of the varying, high velocity, or low temperature characteristics found in space ionized plasma. Particle flows generated by the sun in earth-orbit or in interplanetary or interstellar space plasma can utilize an inlet scoop oriented in the RAM direction to collect plasma in low earth orbit and positionable toward the most efficient space plasma flow direction in higher orbits and in interplanetary space. Plus a control system is used to regulate the magnetic fields surrounding the MHD channel and the radio frequency (RF) voltages surrounding the inlet scoop.

U.S. Pat. No. 3,660,700 A to Aisenberg and Change (1984) is for an electrode-less MHD generator that utilizes a stream of plasma pulses that obtain AC power from a pulsating magnetic field. The seeded, hot gas stream flows through a chamber, FIGS. 1 and 2, that convert the plasma directly from kinetic energy to electricity. This MHD system may be used to generate electricity from a hot, conductive working flow in a terrestrially-based AC generator installation. This is not practicable to extract DC electrical power from cold space-based charged ion plasma because it does not address the issues of the varying, high velocity, or low temperature characteristics found in space ionized plasma. Particle flows generated by the sun in earth-orbit or in interplanetary or interstellar space plasma can utilize an inlet scoop oriented in the RAM direction to collect plasma in low earth orbit and positionable toward the most efficient space plasma flow direction in higher orbits and in interplanetary space. Plus a control system is used to regulate the magnetic fields surrounding the MHD channel and the radio frequency (RF) voltages surrounding the inlet scoop.

U.S. Pat. No. 4,128,776 A to Boquist and Marchant (1977) describes a ceramic-metal composite material capable of use as an electrode for the current collector in a MHD generator channel for use in a high-temperature plasma, up to 2,100° C. This electrode material is useful for generating electricity from an MHD source for electrical power generation that is exposed to thousands of degrees Centigrade. This is not practicable to extract electrical power from space-based, low temperature charged ion plasma because it does not address the issues of the varying, high velocity, or low temperature characteristics found in space ionized plasma. Particle flows generated by the sun in earth-orbit or in interplanetary or interstellar space plasma can utilize an inlet scoop oriented in the RAM direction to collect plasma in low earth orbit and positionable toward the most efficient space plasma flow direction in higher orbits and in interplanetary space. Plus a control system is used to regulate the magnetic fields surrounding the MHD channel and the radio frequency (RF) voltages surrounding the inlet scoop.

U.S. Pat. No. 4,140,931 A to Marchant, D. D., Killpatrick, D. H., Herman, H., and Kuczen, K. D. (1978) describes a porous refractory material applied to the first layer of the MHD generator channel for use in a high-temperature plasma and a second layer of resilient wire mesh in contact with the first layer as a low-temperature current lead-out between the first layer and the frame. Also described is a monolithic ceramic insulator compliantly mounted to the MHD channel frame parallel to the electrode by a plurality of flexible metal strips. This MHD generator channel relates to the usage of high-temperature electrodes for use as current collectors in the channel of a magnetohydrodynamic generator. This electrode material is useful for generating electricity from an MHD source for electrical power generation that is exposed to thousands of degrees Centigrade. This is not practicable for the extraction of electrical power from space-based, low temperature charged ion plasma because it does not address the issues of the varying, high velocity, or low temperature characteristics found in space ionized plasma. Particle flows generated by the sun in earth-orbit or in interplanetary or interstellar space plasma can utilize an inlet scoop oriented in the RAM direction to collect plasma in low earth orbit and positionable toward the most efficient space plasma flow direction in higher orbits and in interplanetary space. Plus a control system is used to regulate the magnetic fields surrounding the MHD channel and the radio frequency (RF) voltages surrounding the inlet scoop.

U.S. Pat. No. 4,523,113 A to Kallman and Johnson (1985) is for an MHD generator that uses a relatively lower temperature (approx. 200° C.) heated fluid, or ionized gas, which is liquid ammonia with dissolved elements (e.g. lithium or sodium) to make it conductive. FIGS. 1 and 2 depict the generator apparatus contemplated in this patent. The design, construction and science of this apparatus works on the basic principles of ground-based MHD. This does not lend itself to practically extract electrical power from space-based, low temperature charged ion plasma particle flows generated by the sun in earth-orbit and interplanetary or interstellar space plasmas because it does not address the issues of the varying, high velocity, or low temperature characteristics found in space ionized plasma for which an inlet scoop oriented in the RAM direction collects plasma in low earth orbit and is positionable toward the most efficient space plasma flow direction in higher orbits and in interplanetary systems. Plus a control system is used to regulate the magnetic fields surrounding the MHD channel and the radio frequency (RF) voltages surrounding the inlet scoop.

U.S. Pat. No. 4,663,548 A to Kato (1987) relates to an arrangement of cathodes in FIG. 1 within a coal-fired MHD power generator in which an elevated temperature combustion gas (2,000 to 3,000° K) is seeded with potassium through the generating field to improve the thermal efficiency of a steam electric generator. The design, construction and science of this combination works on the basic principles of terrestrially-based MHD systems. This does not lend itself usefully to extract electrical power from space-based, low temperature charged ion plasma because it does not address the issues of the varying, high velocity, or low temperature characteristics found in space ionized plasma created by the sun in earth-orbit and interplanetary or interstellar space. An inlet scoop oriented in the RAM direction collects plasma in low earth orbit and is positionable toward the most efficient space plasma flow direction in higher orbits and in interplanetary space. Plus a control system is used to regulate the magnetic fields surrounding the MHD channel and the radio frequency (RF) voltages surrounding the inlet scoop.

U. S. Pat. No. 2012/0104876 A1 to Ma (2012) describes an MHD generator in which multiple magnetic plates are positioned between top and bottom electrodes plates, FIGS. 1 and 2a, with piezoelectric nanowires that vibrate between them to create electric current. This MHD generation approach may also be used to generate electricity from a terrestrially-based generator installation. This is not applicable to the extraction of electrical power from cold space-based charged ion plasma because it does not address the issues of the varying, high velocity, or low temperature characteristics found in space ionized plasma particle flows generated by the sun in earth-orbit or in interplanetary or interstellar space. An inlet scoop oriented in the RAM direction collects plasma in low earth orbit and is positionable toward the most efficient space plasma flow direction in higher orbits and in interplanetary space. Plus a control system is used to regulate the magnetic fields surrounding the MHD channel and the radio frequency (RF) voltages surrounding the inlet scoop.

U.S. Pat. No. 6,107,628 A to Smith, et. al. (2000) relates to a conical-shaped ion-funnel apparatus for screening ions from a gas stream and directing or focusing the dispersed charged particles in the presence of a gas through many, successive layers of larger apertures. A confinement zone is created by applying RF voltages to the aperture elements to control the phase, amplitude and frequency for charged particles of appropriate charge and mass in the interior. This system is useful to analyze the material composition (mass-to-charge ratio of ions) of a particular substance of interest in a mass spectrometer. As an ionization method, it is applicable to vacuum analyzer techniques. It is not practicable to lend itself to the extraction of electrical power from space-based, low temperature charged ion plasma because it does not direct the flow into an MHD channel nor does it address the issues of the varying, high velocity, or low temperature characteristics found in space ionized plasma particle flows generated by the sun in earth-orbit and interplanetary or interstellar space plasmas that utilize a control system for the RF and DC voltages applied to the funnel. This funnel is also mechanically “fixed” in nature and thusly does not “stow” into a compact envelope for launch preparation or “deploy” for on-orbit operation, nor is it positionable toward the RAM direction in orbit.

U.S. Pat. No. 7,064,321 B2 to Franzen (2006) describes an ion funnel for mass spectrometer use that has aperture diaphragms through which flowing gas escapes to the next pump stages and serves to feed the RF and DC voltages. Ions are guided as far as possible through the cone of coaxially arranged aperture diaphragms that taper more and more toward the central outlet hole. The outer shapes of the diaphragms are square with ceramic spacers in the corners of the squares. This ion funnel embodiment arrangement is useful to analyze the material composition of particular substances of interest in mass spectrometers. As such, it is applicable to high-vacuum analyzer techniques. It cannot practically apply itself to focusing space-based, low temperature charged ion plasma to generate electrical power because it does not direct the flow into an MHD channel nor does it address the issues of the varying, high velocity, or low temperature characteristics found in space ionized plasma particle flows generated by the sun in earth-orbit and interplanetary or interstellar space plasmas that utilize a control system for the RF and DC voltages applied to the funnel interior electrode wires. This funnel is also mechanically “fixed” in nature and thusly does not “stow” into a compact envelope for launch preparation or “deploy” for on-orbit operation, nor is it positionable toward the RAM direction in orbit.

U.S. Pat. No. 7,781,728 B2 to Senko, et. al. (2010) describes a device for transporting and focusing ions by tapering the electrode spacing and increasing the oscillatory voltage amplitude coupled to the electrodes in the direction of ion travel, see FIG. 2, to compensate for the influences of gas particle collisions. This ion funnel invention is useful to analyze the material composition of particular substances of interest in mass spectrometers. As such, it is applicable to analyzer techniques. It cannot practically apply itself to focusing space-based, low temperature charged ion plasma to generate electrical power because it does not direct the flow into an MHD channel nor does it address the issues of the varying, high velocity, or low temperature characteristics found in space ionized plasma particle flows generated by the sun in earth-orbit and interplanetary or interstellar space plasmas that can utilize a control system for the RF and DC voltages applied to the funnel interior electrode wires. This funnel is also of a mechanically fixed design that does not “stow” into a compact envelope for launch preparation or “deploy” for on-orbit operation, nor is it intended to be positionable toward the RAM direction in orbit.

U.S. Pat. No. 8,698,075 B2 to Kurulugama and Belov (2014) is for an ion injection process and apparatus in which ions are directly injected orthogonally to the ion guide axis through an inlet on the side of the guide see FIG. 3b. The guide is a stack of square electrode lens plates with interior holes that taper downward into a funnel-shaped cavity. This method reduces contamination of downstream components of mass spectrometers. The electrode lenses can employ an RF field and a DC field of a preselected strength that drives ions introduced from the end of the inlet capillary into the ion guide along the ion guide axis orthogonal to the original ion direction. This ion injection device is useful to analyze the material composition of particular substances of interest in mass spectrometers. As such, it is applicable to material analyzer techniques. It does not, by extension, lend itself to focusing space-based, low temperature charged ion plasma to generate electrical power because it does not direct the flow into an MHD channel nor does it address the issues of the varying, high velocity, or low temperature characteristics found in space ionized plasma particle flows generated by the sun in earth-orbit and interplanetary or interstellar space plasmas that can utilize a control system for the RF and DC voltages applied to the funnel interior electrode wires. This funnel is also of a mechanically fixed design that does not “stow” into a compact envelope for launch preparation or “deploy” for on-orbit operation, nor is it intended to be positionable toward the RAM direction in orbit.

U.S. Pat. No. 9,228,570 B2 to Subrata (2016) involves a small satellite propulsion system that utilizes electrohydrodynamic (EHD) body force to control the flow of propellant through a plenum FIG. 3 to increase the specific impulse created by the propulsion system. A small plasma discharge can be generated in the vicinity of electrode pairs arranged in the expansion slot or micro channel as shown in FIG. 35. This system is useful for employing EHD as a method to augment small satellite propulsion. This is not intended to extract electrical power from space-based charged ion particle flows generated by the sun in earth-orbit or from plasmas in interplanetary missions because it does not address the issues of the varying, high velocity, or low temperature characteristics found in space ionized plasma. An inlet scoop oriented in the RAM direction for space applications collects plasma in low earth orbit and is positionable toward the most efficient space plasma flow direction in higher orbits and in interplanetary space. Plus a control system is used to regulate the magnetic fields surrounding the MHD channel and the radio frequency (RF) voltages surrounding the inlet scoop.

U.S. Pat. No. 9,249,757 B2 to Zauderer (2016) involves the use of a an MHD system with alkali metal seed injection into a natural gas-cooled nuclear reactor to make the gas conductive to induce a Faraday Law electromagnetic field to generate electric power as shown in FIG. 2. This system is suited to large, gas dynamic propulsion systems for terrestrial land, sea and air use. This is not useful to extract electrical power from space-based charged ion particle flows generated by the sun in earth-orbit or from plasmas in interplanetary missions because it does not address the issues of the varying, high velocity, or low temperature characteristics found in space ionized plasma. An inlet scoop oriented in the RAM direction for space applications collects plasma in low earth orbit and is positionable toward the most efficient space plasma flow direction in higher orbits and in interplanetary space. Plus a control system is used to regulate the magnetic fields surrounding the MHD channel and the radio frequency (RF) voltages surrounding the inlet scoop.

U.S. Pat. No. 9,497,846 B2 to Szatlowski, et. al., (2016) describes a plasma generator with a specific arrangement of spiraled conductors and a voltage source coupled across the conductors in FIG. 2 to generate plasma in the dielectric spacing material. This system can be used as a type of conductor in sensing applications, antennas, and lighting. This is not practicable to extract electrical power from charged ion particle flows generated by the sun in earth-orbit or for interplanetary missions or interstellar space plasma because it does not address the issues of the varying, high velocity, or low temperature characteristics found in space ionized plasma. This approach may also be used to generate electricity from a terrestrially-based generator installation. An inlet scoop oriented in the RAM direction is useful for space applications to collect plasma in low earth orbit and positionable toward the most efficient space plasma flow direction in higher orbits and in interplanetary space. Plus a control system is applicable to a space-based system to regulate the magnetic fields surrounding the MHD channel and the radio frequency (RF) voltages surrounding the inlet scoop.

U.S. Pat. No. 9,947,420 B2 to McGuire (2018) is a method to confine electric plasma with magnetic coils in small fusion reactors to prevent the plasma from expanding in such vehicles as aircraft 101, naval 102, and land transportation 103. This system describes a method to extract electrical power from a fusion reactor by an MHD process. It does not describe how to extract electrical power from space-based charged ion particle flows generated by the sun in earth-orbit or for interplanetary missions, because it does not address the issues of the varying, high velocity, or low temperature characteristics found in space ionized plasma. An inlet scoop oriented in the RAM direction is useful for space applications to collect plasma in low earth orbit and positionable toward the most efficient space plasma flow direction in higher orbits and in interplanetary space. Plus a control system is useful to a space-based system to regulate the magnetic fields surrounding the MHD channel and the radio frequency (RF) voltages surrounding the inlet scoop.

U.S. Pat. No. 9,959,942 B2 to McGuire (2018) describes the use of encapsulating, coaxial magnetic coils to confine electric plasma in small fusion reactors to prevent the plasma from expanding in such vehicles as aircraft 101, naval 102, and land transportation 103. This system describes a method to capture the plasma to extract electrical power from a fusion reactor by an MHD process. It does not describe how to extract electrical power from space-based charged ion particle flows in earth-orbit generated by the sun or from plasmas in interplanetary missions, because it does not address the issues of the varying, high velocity, or low temperature characteristics found in space ionized plasma.

U.S. Pat. No. 9,967,963 B2 to Zindler, et. al., (2018) involves a stationary system in FIG. 1 for generating and controlling magnetized plasma using a flux conserver through a self-sustaining compact plasma torus. This is used to control the decay time of a plasma magnetic field and to control the plasma stability. This system does not describe how to extract electrical power from space-based charged ion plasma particle flows in earth-orbit generated by the sun or from plasmas in interplanetary missions because it does not address the issues of the varying, high velocity, or low temperature characteristics found in space ionized plasma. An inlet scoop oriented in the RAM direction is useful for space applications to collect plasma in low earth orbit and positionable toward the most efficient space plasma flow direction in higher orbits and in interplanetary space. Plus a control system is useful for a space-based system to regulate the magnetic fields surrounding the MHD channel and the radio frequency (RF) voltages surrounding the inlet scoop.

U.S. Pat. No. 10,443,139 B2 to Mills (2019) describes an electrical power generation system which uses plasma to extract electric power by injecting a solid fuel into a plasma cloud of electron-stripped atoms, ref. FIG. 14. The ions and excited state atoms could emit light which could then be directed toward photovoltaic cells to convert to electricity. This system does not describe how to extract electrical power from space-based charged ion plasma particle flows in earth-orbit generated by the sun or from plasmas in interplanetary missions. This system relates to creating light that is applied to photovoltaic cells to convert to electricity. It does not address the issues of the varying, high velocity, or low temperature characteristics found in space ionized plasma. An inlet scoop oriented in the RAM direction is useful for space applications to collect plasma in low earth orbit and positionable toward the most efficient space plasma flow direction in higher orbits and in interplanetary space. Plus a control system is useful for a space-based system to regulate the magnetic fields surrounding the MHD channel and the radio frequency (RF) voltages surrounding the inlet scoop.

U.S. Pat. No. 10,686,358 B2 to Serghine, et. al., (2020) describes an MHD system that is placed downstream of the exhaust of a jet turbine engine on top of a helicopter, ref. FIGS. 1 and 2, by recovering at least a portion of the residual energy in the working fluid (exhaust gas) of the turbine. This system places magnets 18a, 18b, and 18c around the periphery of a duct with the magnetohydrodynamic generator electrodes mounted around the nozzle of a rotating turboshaft engine, in particular a turboshaft engine of a rotary wing aircraft. The generator includes a means of injecting elements of ionization into the working fluid and the placement of electrodes to generate electricity. This system does not describe how to extract electrical power from space-based charged ion plasma particle flows in earth-orbit generated by the sun nor from plasmas in interplanetary missions. This system is suited to gas dynamic propulsion (turbine) systems for air-breathing use. This is not practicable to extract electrical power from space-based charged ion particle flows generated by the sun in earth-orbit or from plasmas in interplanetary missions that are already ionized and have no seeding, have an inherently high velocity, and have no use for moving parts within the MHD chamber.

### 3. Discussion of Prior Art, Foreign

Foreign Prior Art Patent Documents are listed here that have been discovered. After review, none have been found to have relevance to the use of MHD generation as applied to the naturally ionized cold plasma from the sun as proposed herein for space-based applications which utilize an inlet scoop oriented in the RAM direction in low earth orbit and also a control system to orient the spacecraft toward the most efficient space plasma flow direction in higher orbits and in interplanetary systems. Additionally, a control system is useful for a space-based system to regulate the magnetic fields surrounding the MHD channel and the radio frequency (RF) voltages surrounding the inlet scoop.

| | | |
|---|---|---|
| AT521022 B1 | Oct. 15, 2019 | Austria |
| BE1003404 A7 | Mar. 17, 1992 | Belgium |
| CH403041 A | Nov. 30, 1965 | Switzerland |
| CH403042 A | Nov. 30, 1965 | Switzerland |
| EP0075294 A1 | Mar. 3, 1983 | EPO, Germany, France |
| EP86903115 A | Mar. 9, 1988 | EPO, Germany, France |
| DE2020010011194 U1 | Feb. 17, 2011 | Germany |
| GB2451290 A | Jan. 28, 2009 | Great Britain |
| JPH08266036 A | Nov. 11, 1996 | Japan |
| CN421270 A | Sep. 30, 1966 | China |
| CN105634242 A | Jun. 1, 2016 | China |
| CN104929803 A | Aug. 24, 2016 | China |
| CN105112878 A | Dec. 2, 2015 | China |
| CN105141107 A | Dec. 9, 2015 | China |
| CN106685180 A | May 3, 2019 | China |
| CN106357708 B | Feb. 14, 2020 | China |
| CN106665180 A | May 3, 2019 | China |
| CN107221370 A | Jun. 9, 2017 | China |
| CN108123587 A | Jun. 5, 2018 | China |
| CN206341126 U | Jul. 18. 2017 | China |
| CN208918960 U | May 31, 2019 | China |
| RU2150778 C1 | Jun. 10, 1996 | Russia |
| RU2409886 C1 | Jan. 20, 2011 | Russia |
| RU2453027 C1 | Jun. 10, 2012 | Russia |
| RU2456735 C1 | Jul. 7, 2012 | Russia |
| RU2529744 C1 | Sep. 27, 2014 | Russia |
| RU2017110519 A | Jan. 16, 2019 | Russia |

### Objects and Advantages

Accordingly, several objects and advantages of this MHD generator system to produce electrical power from collecting and channeling the flow of space-based ionized plasma through from the Solar Wind Flux are:

a) to provide a vast improvement over prior art in design, construction, and ease of use of MHD systems by applying the natural flow of ionized particles (e.g., electrons and protons) in space that emanate from the sun's coronal plasma ejection, as distinct from injecting seeded ions into hot gas or fluid plasmas for terrestrially-based MHD power generation;

b) to provide a much higher power density by weight and volume resulting in a vast improvement over existing solar panel systems by generating significantly more electrical power per unit mass (watts/kg) or electrical power per surface area (watts/square meter) of solar panel exposure to the sun; thus resulting in reduced launch payload mass and on-orbit inertia;

c) to provide a form of spacecraft electrical power generation that will not significantly degrade over time as compared to solar PV panels which are subject to atomic oxygen erosion;

d) to provide an electro-mechanical scoop that may unfold outwardly from a smaller, stowed package envelope and that will act to collect, accelerate, and concentrate the ionized plasma. This will be done by way of projecting an oscillating electromagnetic field inside the shell of the scoop which will contain ion flow and a voltage gradient to accelerate the flow of ions;

e) to provide spacecraft power even when traveling in the shadow of the earth, as opposed to solar PV panels that will not produce power where there is no sunlight, thereby reducing reliance on battery energy storage and further reducing launch payload mass;

f) additional objects and advantages will become apparent from a consideration of the ensuing summary, drawings and description.

### SUMMARY OF THE INVENTION

The present invention relates to a combination of features that work together to convert the flow of highly energized ion particles flowing from the sun outward into the solar system to electrical energy for powering spacecraft onboard functions. It is also able to use ion particles located in the earth's ionosphere, useful for Low Earth Orbit (LEO) applications. It does this by collecting and channeling the existing ion particles (plasma) into a MHD channel using a magnetic field and the natural Lorentz forces to generate power. The conversion of ionization flow to electrical power in the space-based system takes advantage of the ionized plasma already flowing in the ionosphere, the Van Allen Belts and the interplanetary space of our solar system. The proposed space-based MHD generation is significantly different than terrestrial applications. In a terrestrial application of MHD generation, the generator is fixed to the ground, and the ionized plasma is man-made and the direction, velocity, density, and properties of the ionized plasma are controlled.

In the proposed space-based application of MHD generation the characteristics of the ionized plasma is uncontrolled and exists naturally in space with variations in plasma direction, velocity and density (ref's 1, 4 and 5). In a space based MHD generator, control circuit systems can sense and measure the plasma conditions and regulate the voltage magnitude, eliminate voltage transients, control the electromagnet current to regulate power production, and adjust direction, orientation, the voltage field gradient, and the frequency and magnitude of the oscillating rf signal to the inlet scoop on the spacecraft bus body to maximize power production. The ion plasma scoop is designed to funnel and concentrate space plasma. By comparison, terrestrial MHD generators do not utilize any change in orientation or voltage gradients or rf frequency or control circuitry since the ionized plasma direction and properties are controlled. Also for a space-based MHD generator grounding and shielding components eliminate magnetic field interference and static charge arcing that can occur in space that are not found on terrestrial applications. Volume and weight limitations are generally not a concern for terrestrial, ground-based MHD generation design. For space applications, payload launch mass limitations pose a significant concern for a space based MHD generator system. Our proposed space based MHD generation addresses these issues and thus is significantly different than previously patented, terrestrial applications of MHD electrical power generation.

Generally, terrestrial applications of MHD generation cannot produce ionized plasma with the high particle velocities of 7.8 km/sec to 447 km/se pc (17,400 mph-1,000,000 mph) found in space. The ground based applications of MHD generation use very hot gasses seeded with ions that tend to reduce plasma conductivity and thus power generation, with relatively low velocity. This is primarily why terrestrial applications of MHD generation have not been efficient and successful. Whereas space plasma is relatively cold (1-2 eV) and has high conductivity and high velocity, a combination that results in high power production potential, see equation 1 in 2 below.

1. Principle Elements of a Space-Based MHD Generator System

The chief functionality of any MHD channel geometry is that there be a component of the plasma velocity which is perpendicular to the magnetic field, so that a Faraday electric field V X B is created, where V=plasma velocity and B=magnetic field strength. Any moving conductor in a magnetic field will create a voltage potential orthogonal to the current flow on the conductor; thus when a closed loop is present current will flow. Collection and concentration of the space ionized plasma can be done by the use of an electromagnetic ion funnel (see ref's 9 and 10 for examples of ion funnels used in mass spectrometry) which collects and directs the ionized space plasma into a chamber that is configured as a simple Faraday channel with electrodes. The electromagnets are positioned to induce a magnetic field perpendicular to the flow of the ionized plasma. When the ionized conductive plasma flows through the channel, in the presence of the perpendicular magnetic field, ions will migrate due to the Lorentz forces from one anode electrode to the cathode electrode, thus generating a voltage potential with the electrodes placed 90 degrees to the magnetic field.

Accordingly, this present MHD generator system operates by means of an electro-mechanical system comprised of:

a) A converging inlet scoop allowing for precise positioning of the flow direction of ionized plasma, funneling, concentration and acceleration of the ion particles. This ion scoop has a series of spaced ring electrodes whose inner diameters gradually decrease, and serve to radially confine ions as they pass through. Out-of-phase RF potentials are applied to adjacent rings and a DC voltage gradient is applied along the axis of the ion scoop to drive ions (ref. 10) into the MHD channel. This results in higher ion plasma density and velocity, and increased conductivity with resulting plasma current flow to increase power output.

b) A diverging MHD channel with opposing electromagnet polarities and opposing electrode polarities that convert the flow of highly energized ion particles into DC voltage and current flow to the spacecraft loads. The channel is surrounded by a ferromagnetic alloy (commercially referred to as “Mu metal”, ref. 6) metallic box with very high permeability to contain magnetic fields and shield them from influencing surrounding spacecraft RF fields in the vicinity of the MHD generator.

c) A control system comprising control loops and a computer with logic to:
i. regulate the DC voltage output produced from the channel electrodes,
ii. regulate the magnet current due to changes in space plasma density to maintain MHD channel ionic plasma stability, regulate power (watt) production and match spacecraft load, and maximize energy conversion efficiency, and
iii. regulate the voltage and RF signals and DC voltage gradient in the electrode coils surrounding the inlet scoop to focus the ion flow into the MHD channel.

2. Theory of Space-Based MHD Power Generation

Although the naturally occurring ionized plasmas found in low earth orbit (LEO) Solar Wind are relatively low in energy, e.g., 0.2 to 2 electron-volts (EV), and density, e.g., approximately 100 particles/cubic meter (p/m³), the velocity of the ionized plasma is very high, on the order of 7.8 km/s for LEO due to orbital speed of a spacecraft, and 447 km/s for the solar wind beyond LEO, thus resulting in a relatively dense, cold plasma that, when directed through the Faraday MHD channel, can generate a significant amount of power. Satellite probes by the National Aeronautics and Space Administration (NASA) have provided good data regarding the space ionized plasma (ref.'s 4 and 5). The inventors herein have reviewed available scientific data from these probes (e.g. Voyagers I and II) and other related scientific missions.

a) The basic equation for power output for MHD generation is shown below in equation 1, which can be used to analyze the MHD generator performance for various configurations of MHD channel size, magnetic field strength, and plasma scoop size for applications from a small satellite system size to larger versions that can produce higher power. Two metallic electrodes are mounted along the length on opposite sides of the MHD generator channel. Two electromagnets are placed on either side of the MHD generator channel such that the magnetic field would be rotated 90 degrees to the electrode collector surfaces. The electromagnets will be wired to the output of a power regulator control circuit (as shown in FIG. 1). The voltage regulator control circuit will be connected to the electrode collector plates. A computer processor will collect data and make adjustments to the magnet power supply circuit to maintain a regulated magnetic field strength due to the variabilities in the plasma flow. The output of the voltage regulation circuit will ensure that good quality DC voltage will be supplied for a multiplicity of functions onboard the spacecraft. A small permanent magnet will be positioned to project a magnetic field orthogonal to the flow of the direction of the ionized plasma to generate an initial magnetic field during startup.

$$\begin{matrix}equation 1 & \\ P = \frac{{U}^{2} {B}^{2} σ}{4} ( A δ ) , & ( Ref . 7 )\end{matrix}$$

where: P=Total Power Output (watts)
U=Velocity of Plasma electrons (m/s)
B=Magnetic field strength (Tesla)
σ=conductivity of plasma (moh/m) [moh=units of conductivity, or the inverse of resistance]
A=electrode surface (m²)
δ=Distance between electrodes (m)

b) The efficiency of a Faraday MHD generator is determined by equation 2 shown below. The two primary variables affecting the MHD generator efficiency is the electrode separation distance (δ) and the plasma conductivity (σ). Greater electrode separation results in higher efficiency from increased plasma volume. The conductivity of the plasma is determined by the available ionized plasma density and energy in space and the size of the ion scoop.

$$\begin{matrix}equation 2 & \\ {n}_{c} = δ ( 1 - \frac{δ}{2 σ} ) , & ( Ref . 7 )\end{matrix}$$

where: n_{c}=efficiency, %
δ=Distance between electrodes (m)
σ=conductivity of plasma (moh/m)

c) The electron density in LEO is estimated to be about 100 particles per cubic meter. The minimum spacecraft velocity to maintain a low earth orbit is estimated to be 28,000 km/h (7.8 km/s). Thus, as a minimum, with U=velocity of Plasma=7,800 m/s, then the plasma conductivity can be calculated as follows here in equation 3:

$$\begin{matrix}equation 3 & \\ σ = \frac{{n}_{e} {e}^{2}}{{m}_{e} v} , & ( Ref . 8 )\end{matrix}$$

where: U=plasma conductivity (mohs/m)
nₑ=electron density (number of electrons per cubic meter (l/m³)=100
e=atomic unit of charge=1.6×10⁻¹⁹ coulombs
mₑ=electron mass=9.1×10⁻³¹ kg
   Space plasmas usually have low collision rates, thus, for the purposes of this calculation, we can calculate the collision frequency as:

v=collision frequency (l/s)=2.91×10⁻⁶ lnΔX Te=4.365×10⁻⁵

where: Coulomb Logarithm lnΔ=15

Te=1 eV=electron kinetic temperature

Based on data collected from the Van Allen probes, the electron temperature is generally 0.2-2 eV (2000-20,000 K) (Ref. 5). Therefore, the plasma conductivity is:
σ=6.4 mohs/m

d) A performance analysis for different orbital insertions can be performed using these equations by changing various design parameters to determine the effect upon the power output and efficiency of the MHD generator. One parameter can be changed at a time to evaluate the affect on overall performance as measured by the real power output and system efficiency. Results of changing the electromagnetic field strength from 0.5 to 3 Tesla indicates that the power output increases geometrically to the square of the magnetic field strength. A practical electromagnet of reasonable size and weight to fit into the constraints of a small satellite frame size may have an approximate maximum of 1 Tesla field strength. Thus with this magnet size, the power output, after Hall losses and other energy conversion losses, would be about 3.51 kW for low earth orbit plasma conditions, with an efficiency of 5.97%. Increasing the ion scoop size will increase the amount of ionized plasma that is collected and concentrated at the inlet to the MHD generator channel. Analytical results also indicate that increasing the MHD channel and electrode spacing has a dramatic improvement on the energy conversion efficiency and power output. For example, increasing the electrode spacing by 4 times results in increasing the power output by more than 15 times, and almost 4 times improvement in energy conversion efficiency. These results indicate that future, larger MHD generators have the potential to produce even larger amounts of power.

3. Beyond Low Earth Orbit Applications

The performance of an MHD generator appears to be much better when using the ionized plasma of the Solar Wind primarily because the Solar Wind beyond LEO where it is moving at a much higher velocity (400,000 m/s) and the density of the plasma is about six times as dense (600 ionized particles/m³). Thus the power output is much higher using solar wind ionized plasma than the low earth orbit application, about eight times as much. The efficiency of a space-based MHD generator is also improved by about 60%. This analysis indicates that MHD generator will be a good source of energy for interplanetary spacecraft.

### DESCRIPTION OF THE DRAWINGS

An overview of the main components of a space-based MHD generator is depicted in FIGS. 1 through 9.

FIG. 1 shows a perspective pictorial view of the main components with an inlet scoop 2 that receives the ionized particle flux (plasma) 1 from the sun and funnels it through the MHD channel inside the enclosure box 4 to convert the ionized solar plasma into DC electrical voltage and then exits the flow through exhaust port 6.

FIG. 2 shows a sectional view cut through the horizontal center plane which depicts the interior of the tapered MHD channel for the flow of ionized plasma. Circular-shaped, wire-wound electromagnets 7a and 7b are mounted on opposite sides of MHD channel to provide the magnetic field that creates DC voltage flowing over electrodes 9.

FIG. 3 shows a sectional view cut through the vertical center plane depicting the interior of the MHD channel. Wires 10 connect between the electrodes on the top and bottom surfaces. Anti-magnetic enclosure 4 surrounds the channel.

FIG. 4 shows a schematic diagram of the elements of the MHD generating system starting with the entry of particle flux (plasma) 1 into scoop 2 and flowing through channel 8 and then exiting via the exhaust port 6. Channel 8 has electrodes 9a and 9b on the top and bottom surfaces with magnets 7a and 7b rotationally spaced 90 degrees from the electrodes.

FIG. 5 shows a diagram of the central computer function that will control and monitor MHD generation functions.

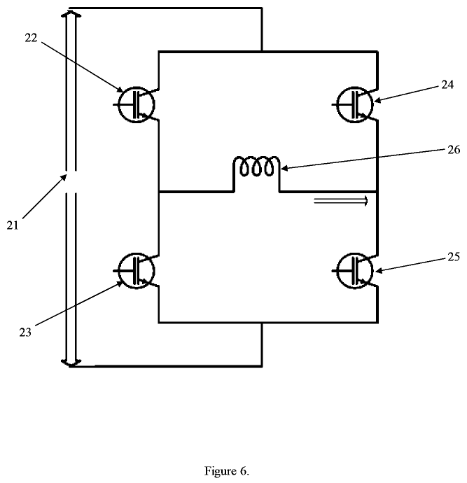

FIG. 6 is a diagram of the bridge current control circuit for the electromagnets.

FIG. 7 shows a schematic of the inlet scoop with interior, circumferential metallic bands that are connected to a series of resistor and capacitor components spaced at 90 degree angles apart.

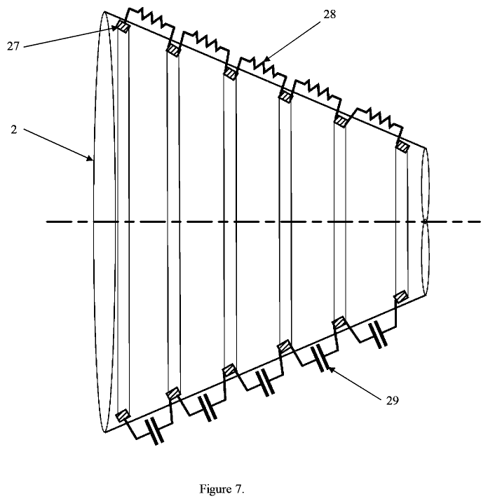

FIG. 8 is a diagram of the voltage regulator circuit to ensure the output matches the spacecraft load demand.

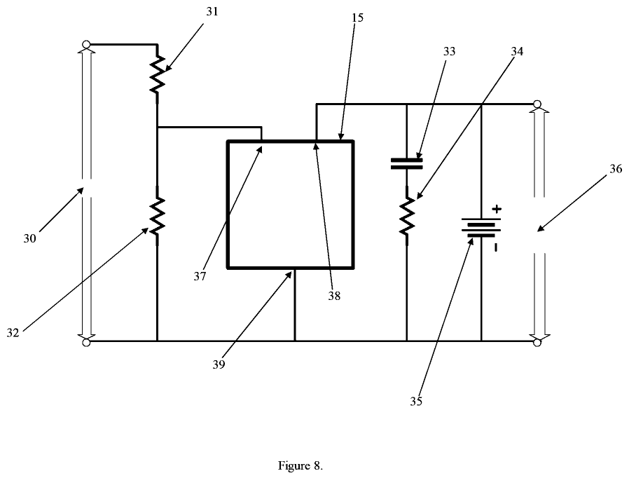

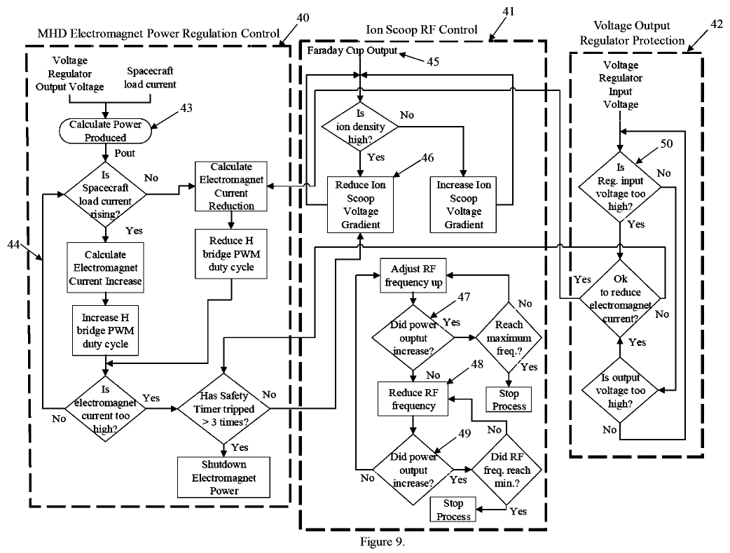

FIG. 9 depicts an overview of the software architecture that is used to receive and interpret functional data to logically regulate and control the MHD channel magnetic field and scoop RF frequency, and to manage network connectivity of the DC power to the spacecraft.

### DESCRIPTION OF THE EMBODIMENT OF THE INVENTION

The form and composition of this MHD electrical power generation system for spacecraft applications is illustrated in the accompanying FIGS. 1 through 9.

FIG. 1 shows a perspective pictorial view of the main exterior components of the MHD generator which has an inlet scoop 2 that receives the ionized particle flux 1 from the sun's plasma and directs it through a channel inside enclosure 4 where the conversion from ionized solar plasma flow into DC electrical voltage occurs and then exits (5a and 5b) through exhaust ports 6. The MU-metal enclosure 4 surrounds the MHD channel to limit the projection of magnetic field lines not to exceed the confines of 4 and not interfere with spacecraft electronics, exterior RF signals or other peripheral magnetic sources. The adapter piece 3 serves to connect the shape of the scoop 2 to the channel inside enclosure 4. The scoop 2 is circumferentially wrapped with metallic bands on the inside surface to create an oscillating RF electromagnetic field and voltage gradient within which the flowing ions will be guided and accelerated into the scoop to the MHD channel, see also FIG. 7, and the voltage to the metallic bands is controlled as described in FIG. 7.

FIG. 2 depicts a cross-sectional view cut through the horizontal center plane of the MHD generator across the interior of enclosure 4 and channel 8 wherein ionized plasma flows and then exits through exhaust port 6. Circular-shaped, wire-wound electromagnets 7a and 7b are mounted on opposite sides of channel 8 to provide the magnetic field across the particle velocity that creates DC voltage flowing between electrodes 9 along the top and bottom surfaces of channel 8. The metal enclosure 4 is shown enveloping the magnets 7a and 7b next to channel 8. It has six pieces with top and bottom surfaces, left and right sides, and forward and aft plates with openings for the inlet and exhaust ports. The adapter 3 serves to connect the small opening of the scoop 2 to the mounting flange on the entrance of channel 8.

FIG. 3 depicts a cross-sectional view through the vertical center plane of the MHD generator across the interior of enclosure 4 and channel 8 wherein ionized plasma flows between electrodes 9, on the top and bottom surfaces, which are mounted orthogonally to electromagnets 7a and 7b. The metal enclosure 4 is shown enveloping the channel 8. The electrodes are wired in series with wires 10 between one another and then to the linear voltage regulator circuit shown in FIG. 8.

FIG. 4 depicts the major interconnected elements of the generation system starting with the entry of particle flux (plasma) 1 into scoop 2 and flowing through channel 8 and then exiting, 5a and 5b, via exhaust port 6. The MHD channel 8 has one electrode 9a mounted on the top and another electrode 9b mounted 180 degrees apart on the bottom, and electromagnets 7a and 7b mounted on the sides that are spaced 90 degrees rotationally from the electrodes. The electrically charged particle flux (plasma) 1 that creates a charge flow across the electrodes 9a and 9b from positive toward negative. This DC voltage that is created flows to a linear voltage regulator circuit 15 within power module 13 to control the input voltage to the battery and other spacecraft functions 16 (27 vdc is commonly used as the principle bus voltage on most spacecraft) via a connectable separation between the MHD generator system and the spacecraft bus electrical system which is used for guidance, navigation and control, instrumentations, and communication. A computer 14, with software, for the MHD system controls and monitors MHD generation functions, including three control loops for voltage regulation, power regulation, ion scoop voltage and RF signal control, and receives data from a Faraday cup (mounted separately aboard the spacecraft) for plasma measurement.

FIG. 5 is a diagram of the central computer control 14 function that receives data inputs from MHD electrode voltage measurements 17 and plasma-state conditions 18 (velocity and density) to determine outputs to the ion scoop voltage and RF signal 19 through the circumferentially-wrapped wires and electromagnet power 20.

FIG. 6 is the power regulation control circuit that is designed to control the current flow through the magnet 26 for control of the magnetic field and thus the power produced by the MHD generator. The basic circuit design of an H-bridge power stage is configured with four power Insulated Gate Bi-polar Transistors (IGBT's). The central computer software will send signals to the IGBT's 22, 23, 24 and 25 to control the current magnitude using Pulse Width Modulation (PWM) to the input of the electromagnets 26. The generator power output value is input to the computer which then, based on the difference between the output and load demand values, controls the duty-cycle of the PWM pulses which corresponds the current amplitude in the desired magnetic field strength in electromagnet coils 26 and the resulting MHD generator power output. Input power to the H-bridge circuit from the spacecraft is depicted in 21. The H-bridge circuit design with PWM gate drives allows control of the electromagnet current magnitude (and thus MHD generator power output) and provides the capability to reverse current direction and magnetic field polarity, which is applicable to changes in polarity of the space ionized plasma charged particle mix.

FIG. 7 is a diagram of the circumferentially-wrapped, electrically conductive strips or wires 27 around the inside surface of the inlet cone-shaped scoop 2. This is thus a stacked ring, radio frequency ion guide with a series of cylindrical ring electrodes. These electrode strips are interconnected by a series of small resistors 28 between adjacent wires running from the front opening to the rear exit. Placed 180 degrees away from the resistors are a series of small capacitors 29 to allow an RF signal to be impressed on adjacent wire rings. This will create a de potential voltage gradient to drive ions along the axis from the front opening to the rear neck of the funnel. Radio Frequency potentials of opposite polarity are applied on adjacent electrodes. The arrangement creates an effective potential (also called pseudo-potential) that radially confines ions inside the ion guide. The effective potential, V*, expressed in Volts, is proportional to the squared amplitude of the local RF electric field E_{rf} This feature takes advantage of the fact that the electrode ring ion guide geometry is naturally “segmented” in the axial direction. The RF signal impressed in the ion scoop electrode rings will be in the range of 600 to 700 kHz depending on ion plasma makeup. A Faraday cup sensor will be mounted outside of the spacecraft to monitor plasma density and space charge. And the control computer will adjust scoop voltage gradient and RF frequency and amplitude to maximize ion scoop performance.

The scoop is constructed of a polymeric material (e.g., Kapton, polyurethane, or other fabric or laminated composite material) that is capable of withstanding the space environment. The scoop membrane 2 could be stowed into a smaller package volume in such a manner that the sequential wire ring(s) 27 concentrically surround nearby adjacent rings to form a flat pancake-like stack. This technique minimizes spatial volume when stowed on the spacecraft bus in preparation for launch. Alternatively, a stowed implementation of foldable polymeric rods could form a more compact arrangement that may deploy outwardly into a larger size scoop opening to collect more charged ions and generate more power. These could be deployed by the stowed strain energy in the folded rods or by mechanical methods (e.g. springs and hinges) that connect via incremental lengths to the scoop membrane 2. A motorized system of driven hinges could also deploy a system of separate rods that support the membrane and wires. These alternative deployment methods could be selected from depending on spacecraft interface needs that affect installation methods, electrical power that may necessitate larger or smaller scoop sizes, and the definition of individual spacecraft missions which could necessitate a specialized system installation or tailored mounting arrangement.

FIG. 8 depicts a block diagram of the linear voltage regulator circuit used to maintain a constant voltage for the spacecraft onboard power for spacecraft operations which is typically tightly controlled within less than 2 to 3%. The proposed voltage regulation control system is designed to adjust voltage 36 to the spacecraft proper level and maintain a constant DC voltage. The MHD electrode voltage in LEO conditions is expected to be 390-492 V, for geosynchronous earth orbit (GEO) and deep space MHD electrode voltages will range from 24-50 kV. Usually, spacecraft load voltage needs to be about 27 vdc. So a voltage divider circuit (e.g. a buck regulator circuit) will be used to step-down the voltage to 15-27 volts. This voltage will be used as an input to the linear voltage regulator circuit which employs negative feedback and will provide a smooth output voltage for spacecraft operations. An energy storage battery 35 will be used to store energy and to smooth out any voltage spikes, and ensure good power quality 36 to the spacecraft. The voltage input from the MHD electrodes comes in from 30. The circuit has the three resistors 31, 32 and 33 and a capacitor 33. Voltage input to 15 is 37, voltage output is 38 and connection to ground/common is 39.

FIG. 9 depicts the logic of the software architecture that is used to receive and interpret functional data, logically decide and regulate the MHD channel magnetic field and the scoop electromagnetic field, manage network connectivity and control the DC power level. Decisions are made based on the voltage and current generated in the MHD channel and received from the electrodes and flowing to the spacecraft battery to adjust up or down the inlet cone voltage and electromagnet voltages. In this diagram, software is divided into three functions: a) MHD Electromagnet Power Regulation Control 40, b) Ion Scoop RF power Control 41, and c) Voltage Output Regulator Protection for power output to the spacecraft 42.

a) Block 40 in FIG. 9 shows within it the software logic steps to control the MHD power regulation. The control of power output created by the MHD generator ensures that it matches spacecraft load demand 43. The amount of power generated by the MHD generator is dependent on space ion plasma conditions, and the spacecraft load demand that periodically changes. This power regulation control loop 44 regulates and controls the amount of power that is generated and match spacecraft demand. The MHD generator power output (see equation 1) is proportional to the square of plasma velocity, and the magnetic field strength produced by the electromagnet, and directly proportional to the plasma conductivity and distance the electrodes are separated. The magnetic field produced by the electromagnet is the variable that can be controlled and adjusted to change the amount of power that is being generated. The magnetic field strength is directly proportional to the amount of current that is circulated through the electromagnet, as shown in equation 4. Our electromagnet will be a solenoid coil with a ferromagnetic core which will have a high magnetic permeability.

B=μNI equation 4 (reference 11)
where: B=Magnetic field strength (Tesla)
   μ=magnetic permeability (T amp/m)
   N=number of turns of coil
   I=Amps
      The power regulation control is designed to control the current flow through the magnet and thus control the magnetic field and power produced by the MHD generator. The basic circuit design of an H-bridge power stage is configured with four power IGBT's as shown in FIG. 6.

b) Block 41 in FIG. 9 shows the software logic steps to adjust the RF frequency and voltage of the system of metallic strips, resistors and capacitors that surround the cone of the inlet scoop. Depending on the value of the ion density as measured by a Faraday Cup 45, the ion scoop voltage gradient 46 is adjusted up or down. If the resultant power output of the MHD channel increases, then, if the maximum frequency is reached, the RF frequency adjustment is stopped 47. If it did not increase, then the RF frequency is reduced 48. The power output is again checked and the RF frequency is adjusted accordingly 49.

c) Block 42 in FIG. 9 shows within it the software steps to logically decide and regulate power output to the spacecraft as a protection measure to prevent an over-voltage condition to the spacecraft energy storage battery. Since the DC voltage produced at the MHD channel electrodes is directly proportional to the ion particle velocity in the MHD channel, the distance between the anode and cathode, and the magnetic field strength created by the electromagnet, as shown previously in equation 1, then the voltage produced at the electrodes can vary if any of these variables change significantly. The equation for the calculation of open circuit voltage is shown in equation 5 below and is used in 50.

Voc=B×ν×δ equation 5 (reference 7)
where: Voc=open circuit voltage
   B=Magnetic field strength of electromagnet (Tesla)
   ν=ion particle velocity (meters/second)
   δ=electrode separation distance (meters)

A constant voltage for the spacecraft onboard power maintains spacecraft operations. The onboard electronics on spacecraft operate within a fairly tight voltage regulation (<2-3%). In LEO the ion particle velocity is primarily determined by the orbital speed of the spacecraft and is not expected to vary significantly after insertion into orbit. In GEO and deep space the solar wind ion particle velocity can vary significantly. The distance between electrode plates is constant, and therefore will not cause any change in voltage. The magnetic field strength from the electromagnet will be changing due to the power regulation control circuit, which will be automatically adjusting power output to match changing spacecraft load and variations in the plasma characteristics. Because of these variations in the magnetic field strength and plasma conditions, voltages at the electrodes will vary significantly. This hardware controlled voltage regulation control system with software protection, adjusts the voltage to the proper level and maintains a constant supply.

It is to be understood from the foregoing that, while particular implementations have been illustrated and described, various modifications can be made thereto and are contemplated herein. It is also not intended that this MHD generator system be limited by the specific examples provided within the specification. While the MHD generator system has been described with reference to the aforementioned specification, the descriptions and illustrations of the preferable embodiments herein are not meant to be construed in a limiting sense. Furthermore, it shall be understood that the aspects of this MHD generator system is not limited to the specific depictions, configurations or relative proportions set forth herein which depend upon a variety of conditions and variables. Various modifications in form and detail of the space-based MHD generator system will be apparent to a person skilled in the art. It is therefore contemplated that the system shall also cover any such modifications, variations and equivalents

We claim:

1. An electro-mechanical inlet scoop comprises a funnel shape that directs a flow of space-based ionized plasma into an opening of a MHD channel.

2. An inlet scoop of claim 1 further comprises a set of sequentially-spaced electrode wire rings around an inside surface of which gradually decrease in diameter in accordance with an angular slope change of the inlet scoop.

3. Wire rings in claim 2 further comprise a confinement and guidance of ions by applying out-of-phase RF potentials to these rings and a DC voltage gradient along a longitudinal axis of the inlet scoop.

4. An inlet scoop of claim 1 further comprises a mechanical ring located to mechanically affix it to an entrance of the MHD channel.

5. A control system comprises three control loops with regulators and a computer with software logic to maintain a voltage produced from a pair of collector electrodes, adjust a magnetic field current so spacecraft power is within an operational range, and control RF potentials and a DC voltage gradient to rings on a scoop inside surface.

6. This system of controls in claim 5 further receives feedback from a spacecraft voltage level to determine adjustments that will match a spacecraft electrical load.

7. The control system of claim 5 further has a loop within it to adjust current flowing to a pair of electromagnets to control a magnetic field strength which results in regulating a produced power.

8. A second control loop within the control system of claim 5 comprises adjustments to the voltage produced by a pair of MHD electrodes to maintain transient-free output voltage to a battery that stores energy to ensure that it is within an operational tolerance for a spacecraft.

9. A third control loop within the control system of claim 5 further adjusts voltages to wire electrodes that surround the inside surfaces of an inlet scoop to maintain an electromagnetic RF field and voltage gradient to guide plasma particles inwardly toward a MHD generator channel inlet.

10. An MHD channel that comprises a wedge shape with a rectangular cross-section that varies in dimension passes high-velocity ionized solar plasma through it to concentrate a plasma flow and expand it through exhaust ports.

11. The MHD channel of claim 10 further comprises a pair of conductive electrodes mounted on opposite sides of that are orthogonal to a magnetic field.

12. The MHD channel of claim 10 further comprises a pair of electromagnets constructed of a toroid of conductive copper wire wound around a circular ferro-magnetic core that are positioned halfway along a length to provide a magnetic field that is projected across at a right angle.

13. The MHD channel of claim 10 is further surrounded by a metallic box enclosure that limits magnetic field lines from projecting outwardly thereby preventing interference with exterior spacecraft RF signals and other magnetic sources.
